(19) United States
(12) Patent Application Publication
(10) Pub. No.: US 2026/0233754 A1
(43) Pub. Date: Aug. 13, 2026

(54) APPARATUS FOR FACILITATING A MOVEMENT OF ONE OR MORE TRAILERS

(71) Applicant: Muhammad Azhar Jehangir, Thornhill Vaughan (CA)

(72) Inventor: Muhammad Azhar Jehangir, Thornhill Vaughan (CA)

(21) Appl. No.: 19/535,886

(22) Filed: Feb. 10, 2026

Related U.S. Application Data
(63) Continuation-in-part of application No. 63/756,683, filed on Feb. 10, 2025.

(51) Int. Cl. B60W 60/00; B60L 50/60; B60L 53/51; B60L 53/52; B60L 53/57; B60W 10/04; B60W 10/20; B62D 13/00; B62D 53/06; B62D 59/04; H02S 10/12; H02S 20/30; G06Q 40/04

(52) U.S. Cl. CPC B60W 60/001; B60L 50/60; B60L 53/51; B60L 53/52; B60L 53/57; B60W 10/04; B60W 10/20; B62D 13/00; B62D 53/06; B62D 59/04; H02S 10/12; H02S 20/30; B60L 2200/28; B60W 2300/145; B60W 2556/45; B60W 2710/20; G06Q 40/049

(57) ABSTRACT

An apparatus for facilitating a movement of trailers. The apparatus includes energy harvesting devices, energy storage devices, trailer propulsion assemblies, and a processing device. The energy harvesting devices are coupled to trailer bodies of the trailers, and generate electrical energy. The energy storage devices are coupled to the trailer bodies, and electrically coupled with the energy harvesting devices, and store the electrical energy. The trailer propulsion assemblies are coupled to the trailer bodies, and operatively coupled with wheels mounted on the trailer bodies, and drive the wheels with driving characteristics using the electrical energy for propelling the trailers. The trailers are maneuverable. The processing device are operatively coupled with the trailer propulsion assemblies, the energy storage devices, and the energy harvesting devices, and generates commands for controlling a movement of the trailers. The driving of the wheels with the driving characteristics using the electrical energy are based on the commands.

### REFERENCE TO RELATED APPLICATIONS

This application claims the benefit of U.S. Provisional Patent Application No. 63/756,683, titled “SMART-VEHICLE SYSTEMS”, filed February 10, 2025, which is incorporated by reference herein in its entirety.

### FIELD OF THE INVENTION

Generally, the present disclosure relates to the field of transportation. More specifically, the present disclosure relates to an apparatus facilitating a movement of one or more trailers.

### BACKGROUND OF THE INVENTION

The present disclosure relates generally to the field of transportation and mobility systems, and more particularly to electrically powered and energy-efficient vehicle platforms used in freight and logistics operations. Transportation systems play a critical role in enabling the movement of goods across regional, national, and global supply chains, and advancements in this field directly impact economic efficiency, environmental sustainability, and operational scalability. As freight volumes continue to increase and regulatory and environmental pressures intensify, there is growing importance placed on developing transportation solutions that are adaptable, energy-efficient, and capable of operating with reduced environmental impact.

A desirable objective in this field is to enable freight transport platforms to operate with increased energy autonomy and operational flexibility while reducing dependency on external power sources and complex mechanical arrangements. Achieving such an objective may allow logistics operations to improve efficiency, reduce downtime, optimize energy usage, and better support emerging electrification and sustainability initiatives. Additionally, it is desirable for freight transport systems to support flexible operational modes, including movement, staging, and parking, without requiring constant reliance on external vehicles or infrastructure.

However, existing approaches for achieving this objective present several challenges. Many freight transport platforms are heavily dependent on separate propulsion units, which can limit operational independence and constrain maneuverability in confined environments. Energy supply for such platforms is often centralized or externally sourced, resulting in inefficiencies, limited energy availability during idle or stationary periods, and increased reliance on charging or refueling infrastructure. Furthermore, existing systems may struggle to effectively utilize ambient energy sources or to manage energy storage and distribution in a manner that supports sustained and flexible operation across varying conditions. These limitations can lead to reduced operational efficiency, increased energy consumption, and constraints on deployment in diverse logistical scenarios.

Further, freight transportation systems play a central role in regional, national, and global supply chains. Conventional freight transport relies on tractor-trailer configurations in which propulsion, braking authority, and maneuvering capability are provided exclusively by a tractor unit, while the semi-trailer functions as a passive load-bearing structure.

As freight volumes increase and environmental and regulatory pressures intensify, there is a growing need for transportation platforms that are more energy-efficient, operationally flexible, and compatible with emerging electrification and automation initiatives. Autonomous driving technologies and alternative energy systems have advanced primarily at the tractor level, leaving the trailer largely unaddressed in terms of propulsion and energy management.

Conventional semi-trailers lack independent mobility and are unable to generate tractive force, which limits maneuverability during low-speed operations, yard movements, staging, and docking. Additionally, reliance on a tractor-only propulsion architecture results in increased drivetrain losses, higher fuel consumption, and reduced redundancy during degraded operating conditions.

Existing approaches that attempt to improve freight efficiency often rely on centralized or external energy sources, complex mechanical couplings, or specialized tractor platforms, thereby limiting retrofit compatibility and increasing infrastructure dependency. Such approaches may also inadequately utilize ambient or supplemental energy sources and may fail to provide flexible operating modes across varying logistical scenarios.

Accordingly, there exists a need for a trailer-centric propulsion and control architecture that enables a semi-trailer to independently generate tractive force, selectively assist a coupled tractor unit, and operate autonomously or under remote supervision, while remaining compatible with existing tractor platforms and trailer designs.

Therefore, there is a need for an improved apparatus for facilitating a movement of one or more trailers that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

Disclosed herein is an apparatus for facilitating a movement of one or more trailers, in accordance with some embodiments. Accordingly, the apparatus may include one or more energy harvesting devices, one or more energy storage devices, one or more trailer propulsion assemblies, and a processing device. Further, the one or more energy harvesting devices may be coupled to one or more trailer bodies of the one or more trailers. Further, the one or more energy harvesting devices may be configured for generating electrical energy by harvesting energy from an environment of the apparatus. Further, the one or more energy storage devices may be coupled to the one or more trailer bodies. Further, the one or more energy storage devices may be electrically coupled with the one or more energy harvesting devices. Further, the one or more energy storage devices may be configured for storing the electrical energy. Further, the one or more trailer propulsion assemblies may be coupled to the one or more trailer bodies. Further, the one or more trailer propulsion assemblies may be operatively coupled with one or more wheels mounted on the one or more trailer bodies. Further, the one or more trailer propulsion assemblies may be configured for driving the one or more wheels with one or more driving characteristics using the electrical energy for propelling the one or more trailers. Further, the one or more trailers may be maneuverable. Further, the processing device may be operatively coupled with the one or more trailer propulsion assemblies, the one or more energy storage devices, and the one or more energy harvesting devices. Further, the processing device may be configured for generating one or more commands for controlling at least one movement of the one or more trailers. Further, the driving of the one or more wheels with the one or more driving characteristics using the electrical energy may be based on the one or more commands.

Further disclosed herein is an apparatus for facilitating a movement of one or more trailers, in accordance with some embodiments. Accordingly, the apparatus may include one or more trailers, one or more energy harvesting devices, one or more energy storage devices, one or more trailer propulsion assemblies, and a processing device. Further, the one or more trailers may include one or more trailer bodies and one or more wheels. Further, the one or more wheels may be mounted on the one or more trailer bodies. Further, the one or more energy harvesting devices may be coupled to the one or more trailer bodies of the one or more trailers. Further, the one or more energy harvesting devices may be configured for generating electrical energy by harvesting energy from an environment of the apparatus. Further, the one or more energy storage devices may be coupled to the one or more trailer bodies. Further, the one or more energy storage devices may be electrically coupled with the one or more energy harvesting devices. Further, the one or more energy storage devices may be configured for storing the electrical energy. Further, the one or more trailer propulsion assemblies may be coupled to the one or more trailer bodies. Further, the one or more trailer propulsion assemblies may be operatively coupled with the one or more wheels. Further, the one or more trailer propulsion assemblies may be configured for driving the one or more wheels with one or more driving characteristics using the electrical energy for propelling the one or more trailers. Further, the one or more trailers may be maneuverable. Further, the processing device may be operatively coupled with the one or more trailer propulsion assemblies, the one or more energy storage devices, and the one or more energy harvesting devices. Further, the processing device may be configured for generating one or more commands for controlling at least one movement of the one or more trailers. Further, the driving of the one or more wheels with the one or more driving characteristics using the electrical energy may be based on the one or more commands.

Further disclosed herein is an apparatus for facilitating a movement of one or more trailers, in accordance with some embodiments. Accordingly, the apparatus may include one or more trailers, one or more energy harvesting devices, one or more energy storage devices, one or more trailer propulsion assemblies, a processing device, and one or more steering assemblies. Further, the one or more trailers may include one or more trailer bodies, one or more wheels, and one or more steerable wheels. Further, the one or more wheels may be mounted to a rear portion of the one or more trailer bodies. Further, the one or more steerable wheels may be mounted to a front portion of the one or more trailer bodies. Further, the one or more energy harvesting devices may be coupled to the one or more trailer bodies of the one or more trailers. Further, the one or more energy harvesting devices may be configured for generating electrical energy by harvesting energy from an environment of the apparatus. Further, the one or more energy storage devices may be coupled to the one or more trailer bodies. Further, the one or more energy storage devices may be electrically coupled with the one or more energy harvesting devices. Further, the one or more energy storage devices may be configured for storing the electrical energy. Further, the one or more trailer propulsion assemblies may be coupled to the one or more trailer bodies. Further, the one or more trailer propulsion assemblies may be operatively coupled with the one or more wheels. Further, the one or more trailer propulsion assemblies may be configured for driving the one or more wheels with one or more driving characteristics using the electrical energy for propelling the one or more trailers. Further, the one or more trailers may be maneuverable. Further, the processing device may be operatively coupled with the one or more trailer propulsion assemblies, the one or more energy storage devices, and the one or more energy harvesting devices. Further, the processing device may be configured for generating one or more commands for controlling at least one movement of the one or more trailers. Further, the driving of the one or more wheels with the one or more driving characteristics using the electrical energy may be based on the one or more commands. Further, the one or more steering assemblies may be coupled to the one or more trailer bodies. Further, the one or more steering assemblies may be configured for steering the one or more steerable wheels based on the one or more commands. Further, the one or more trailers may be maneuvered based on the steering of the one or more steerable wheels.

Further disclosed herein is a self-propelled semi-trailer system in which propulsion, energy storage, and control intelligence are integrated directly into a trailer body. Further, the self-propelled semi-trailer is configured to operate in two or more selectable operating modes. Further, the two or more selectable operating modes may include a self-propelled mode in which the trailer generates tractive force independently of a tractor engine. Further, the two or more selectable operating modes may further include a tractor-assisted mode in which the trailer provides forward propulsion while mechanically coupled to a tractor unit, thereby reducing propulsion torque demand on the tractor unit. Further, in some embodiments, the self-propelled semi-trailer includes one or more electric propulsion assemblies operatively coupled to trailer wheels, an onboard energy storage assembly mounted to the trailer chassis, and a trailer-resident electronic control unit (ECU). Further, the ECU is configured to generate propulsion control commands based on operating conditions, energy availability, and received control signals, and to coordinate propulsion output with a coupled tractor unit when present. Further, unlike conventional systems in which propulsion authority resides exclusively in the tractor, the disclosed architecture relocates propulsion generation closer to the transported load. Further, the given configuration reduces drivetrain losses, improves traction management, enhances low-speed maneuverability, and increases overall energy efficiency.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side view of an apparatus 100 for facilitating a movement of one or more trailers 102, in accordance with some embodiments.

FIG. 2 is a side view of the apparatus 100 for facilitating the movement of the one or more trailers 102, in accordance with some embodiments.

FIG. 3 is a side view of the apparatus 100 for facilitating the movement of the one or more trailers 102, in accordance with some embodiments.

FIG. 4 is a side view of the apparatus 100 for facilitating the movement of the one or more trailers 102 with the tractor 402, in accordance with some embodiments.

FIG. 5 is a side view of the apparatus 100 for facilitating the movement of the one or more trailers 102 with the tractor 402, in accordance with some embodiments.

FIG. 6 is a side view of the tractor 402 associated with the apparatus 100, in accordance with some embodiments.

FIG. 7 is a side view of the tractor 402 associated with the apparatus 100, in accordance with some embodiments.

FIG. 8 is a side view of the apparatus 100 for facilitating the movement of the one or more trailers 102, in accordance with some embodiments.

FIG. 9 is a side view of the two or more trailers (102 and 902) of the apparatus 100, in accordance with some embodiments.

FIG. 10 is a side view of the apparatus 100 for facilitating the movement of the one or more trailers 102, in accordance with some embodiments.

FIG. 11 is a side view of the apparatus 100 for facilitating the movement of the one or more trailers 102, in accordance with some embodiments.

FIG. 12 is a front view of the one or more energy harvesting devices 104 of the apparatus 100 for facilitating the movement of the one or more trailers 102, in accordance with some embodiments.

FIG. 13 is a front view of the one or more energy harvesting devices 104 of the apparatus 100 for facilitating the movement of the one or more trailers 102, in accordance with some embodiments.

FIG. 14 is a side view of the apparatus 100 for facilitating the movement of the one or more trailers 102, in accordance with some embodiments.

FIG. 15 is a side view of a trailer 1500 for facilitating movement of the trailer 1500, in accordance with some embodiments.

FIG. 16 is a front view of a trailer system 1600 for facilitating movement of the trailer system 1600, in accordance with some embodiments.

FIG. 17 is a rear view of the trailer system 1600 for facilitating movement of the trailer system 1600, in accordance with some embodiments.

FIG. 18 is a left side view of the trailer system 1600 for facilitating movement of the trailer system 1600, in accordance with some embodiments.

FIG. 19 is a top view of the trailer system 1600 for facilitating movement of the trailer system 1600, in accordance with some embodiments.

FIG. 20 is a right side view of the trailer system 1600 for facilitating movement of the trailer system 1600, in accordance with some embodiments.

FIG. 21 illustrates a trailer 2102 traversing autonomously on a road, in accordance with some embodiments.

FIG. 22 illustrates a user 2202 controlling the trailer 2102 from a remote location, in accordance with some embodiments.

FIG. 23 is a flow diagram of a method 2300 for facilitating a movement of a trailer, in accordance with some embodiments.

FIG. 24 is a perspective view of a wind energy harvesting device 2402, in accordance with some embodiments.

FIG. 25 is a block diagram of a smart-vehicle system 2500, in accordance with some embodiments.

FIG. 26 is a side view of an apparatus 2600 for facilitating a movement of one or more trailers 2602, in accordance with some embodiments.

FIG. 27 is a side view of an apparatus 2700 for facilitating a movement of one or more trailers 2702, in accordance with some embodiments.

FIG. 28 is an illustration of an online platform 2800 consistent with various embodiments of the present disclosure.

FIG. 29 is a block diagram of a computing device 2900 for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating a movement of one or more trailers, embodiments of the present disclosure are not limited to use only in this context.

In general, the method disclosed herein may be performed by one or more computing devices. For example, in some embodiments, the method may be performed by a server computer and/or the computing device in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer and/or the computing device may be and/or may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer and/or the computing device may be and/or may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer and/or the computing device may be and/or may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

### Overview

The present invention describes an apparatus for facilitating a movement of one or more trailers. Further, the present disclosure describes a renewable energy-propelled semi-trailer system that integrates solar paint, solar thin-film panels, and wind turbines for energy harvesting. Further, the apparatus may include the renewable energy-propelled semi-trailer system. In combination, the tractor unit provides steering and navigation control, syncing seamlessly with the trailer’s driving mechanisms for enhanced operational efficiency. The present disclosure features a wireless charging capability, a net metering system, and an autonomous operation mechanism via a humanoid robot. Designed for efficiency and sustainability, the trailer supports multi-trailer towing, reducing emissions and optimizing long-haul delivery operations. Additionally, the invention promotes a human-friendly employment model by allowing truck operators to work remotely, improving their quality of life and increasing income opportunities. Trailers parked at docks further act as power generators for warehouses, enhancing energy efficiency and cost savings. To ensure safety, a thermal blanket system is incorporated to contain battery fires and prevent environmental hazards.

The present disclosure relates to autonomous transportation systems and, more specifically, to the modification of existing semi-trailer units as well as new units into autonomous, self-driven electric vehicles (EVs) equipped with multiple renewable energy systems and advanced control and navigation features.

The present invention provides a system and method to retrofit existing semi-trailer units, enabling them to function autonomously. The retrofitted unit incorporates:

1. Autonomous Drive Mechanism:

Rear wheels are equipped with high-torque electric motors powered by an onboard lithium battery pack mounted beneath the trailer frame.

Two additional steerable front wheels are installed to facilitate turning and precise maneuvering, controlled via a remote steering mechanism.

2. Energy Regeneration:

When braking or in low-speed conditions, the system may include regenerative braking technology that captures and stores energy back into the system’s batteries.

3. Navigation and Safety Systems:

LiDAR sensors, cameras, and ultrasonic sensors are installed at the front, sides, and rear of the unit for real-time environmental mapping and navigation.

Integrated safety features include automatic braking, collision avoidance, lane assistance, and proximity alerts.

4. Renewable Energy Integration:

The trailer frame is coated with solar paint and thin film panels to harvest solar energy during daylight.

Compact high-efficiency wind turbines are installed at strategic locations on the trailer to capture wind energy during motion.

The energy harvested by these systems is used to recharge the onboard battery, reducing reliance on external charging stations.

5. Wireless Charging:

The unit is equipped with a wireless inductive charging system that interfaces with underlayment charging pads installed at docks, parking areas, or rest stops. This enables convenient and efficient battery recharging without manual intervention.

6. Independent and Collaborative Operation:

The trailer unit can be operated independently via a remote control system, allowing it to travel autonomously between locations without the need for a tractor unit.

When connected to a tractor, the system enables the creation of a "train" of multiple trailers. Unlike conventional systems where the tractor pulls the trailer, in this invention, the autonomous trailer actively propels the tractor using its onboard electric motors, reducing strain on the tractor's engine and improving fuel efficiency.

The tractor integrates with the trailers via a centralized communication protocol that connects the tractor’s control systems to the trailer’s onboard drive control systems. This allows the tractor to transmit commands related to acceleration, braking, steering, and route adjustments to the trailers. The trailer’s propulsion system aids in synchronizing movements, effectively allowing the trailer to assist or even lead in driving operations under certain conditions.

A humanoid robot installed in the lead trailer or tractor acts as an intermediary between the control room and the trailer systems. Commands issued by the operator from the control room are transmitted wirelessly to the robot, which simulates human actions to control the trailer train. The robot operates physical interfaces, such as steering wheels and brake controls, within the tractor while also managing digital commands to optimize synchronization with the trailer systems.

7. Modification of Controls:

The invention includes a retrofit bypass system to switch existing IC/diesel engine controls to EV-specific controls for braking, acceleration, and other cockpit functions. The system is equipped with:

Switch Interfaces: Physical and digital switches installed in the tractor cabin allow operators to toggle between diesel-powered and EV-powered modes seamlessly.

Control Adaptation Unit: This unit intercepts signals from the existing control interfaces (e.g., accelerator pedal, brake pedal, and dashboard instruments) and translates them into commands suitable for the trailer's EV propulsion system. For instance, pressing the accelerator in EV mode sends a signal to the trailer’s electric motors to adjust torque and speed accordingly.

Integrated Brake Controls: The braking system is modified to integrate regenerative braking capabilities from the trailer’s electric motors. The operator’s input on the brake pedal is distributed between the tractor’s conventional brakes and the trailer’s regenerative system, ensuring smooth and efficient braking.

Cockpit Integration: A touchscreen display in the tractor cabin provides real-time updates on trailer performance, battery status, and energy consumption. The interface also allows the operator to adjust settings such as propulsion assist levels and navigation preferences.

In some embodiments, the present disclosure may include the following aspects:

1. Structural Modifications:

The addition of two front wheels with independent suspension and steering systems allows the trailer to maneuver autonomously. The front axle assembly is integrated with electric actuators for remote steering.

The rear axle assembly is retrofitted with in-wheel electric motors capable of delivering sufficient torque for hauling cargo.

2. Steering and Navigation

Steering Mechanism for Trailers: If the trailers are long or articulated, each trailer may need to have its own steering mechanism. This could be done via a steering axle on the front of each trailer, which would allow the trailer to steer in response to commands from the tractor.

The trailers’ wheels could be independently controlled using electric steering motors, which are synchronized with the tractor's steering. The tractor would send signals to the trailers to adjust their steering angles during turns.

3. Automatic Steering Control: Advanced systems can employ automatic steering to steer the entire train. The tractor will control the overall trajectory, but the trailers could use sensors or actuators to follow the path of the tractor with minimal human intervention.

4. Control Systems for Coordination

Distributed Control System: A centralized control unit located on the tractor could manage the motion of both the tractor and the trailers. The control unit would need to integrate: Speed synchronization (so all trailers move at the same speed as the tractor).

Independent control of each trailer’s motor to facilitate turning or braking.

Communication with sensors and actuators on each trailer for steering control.

5. Sensor Integration: Sensors on both the tractor and trailers (such as cameras, LiDAR, GPS, or accelerometers) can help maintain synchronization between the tractor and trailers, ensuring that trailers follow the tractor’s path and react to steering inputs.

6. Energy Management System:

Solar paint, along with transparent thin-film cells applied to the trailer surface, captures sunlight and converts it into electrical energy through photovoltaic cells embedded in the paint.

Compact high-efficiency horizontal-axis wind turbines are mounted on the trailer edges and front roof, generating power as airflow passes over the trailer during transit motion, especially at night.

An energy management unit optimizes the distribution of harvested energy to the lithium battery pack and onboard systems.

7. Control and Navigation:

LiDAR sensors create a 3D map of the surrounding environment, enabling obstacle detection and route planning.

Cameras and ultrasonic sensors provide redundant data streams for enhanced safety and decision-making.

A centralized control unit processes sensor inputs to autonomously steer, accelerate, and brake the trailer as required.

8. Safety Features:

Adaptive braking systems automatically engage during emergency scenarios to prevent collisions.

Lane-assist technology ensures the trailer remains within designated lanes during autonomous operation.

9. Humanoid Robot Control Interface:

A humanoid robot is equipped with cameras, a mic & speakers and installed in the lead tractor for operations involving a trailer or multiple trailers in a "train" configuration. The robot simulates human inputs based on commands received from a remote operator in the control room.

The robot receives wireless commands through a secure communication network, which relays operator inputs such as speed adjustments, steering corrections, and emergency stop signals.

The robot interfaces with the steering and braking systems of the trailers, ensuring synchronized operation. It also monitors the status of all connected trailers, relaying critical information back to the control room to facilitate real-time adjustments and ensure operational safety.

10. Net Metering and Energy Management System: The system includes an energy management unit that monitors energy flow, storing power from solar and wind sources, and distributing it according to needs. The system integrates with smart grid technologies that communicate with the local utility for net metering, allowing the system to export surplus energy to the grid during off-peak hours.

The net metering system ensures that the energy credits generated by surplus energy can be tracked and credited to the trailer owner’s utility account. This integration can contribute to reducing operational costs for transportation and offer a revenue stream from energy production.

The system includes net metering capabilities that allow the excess energy generated by the solar panels and wind turbines to be fed back into the electric grid or stored in local systems for future use.

The net metering system tracks energy generation via an app provided to every unit owner, usage, and export, ensuring proper credit or financial compensation for the energy supplied to the grid or shared with external users.

11. Wireless EV Charging System:

The semi-trailer is equipped with a wireless EV charging unit (using inductive or resonant coupling technology) in underlayment pavement or physical superchargers to transmit and receive charge (EVs) in the building, such as during parking or docking.

The charging system is capable of transferring power wirelessly from the trailer to the EV without the need for plugs or cables, making it more efficient and convenient for fleet operations. o Wireless EV Charging system shall be capable of cumulative transmission of energy via interconnectivity of the units parked to the building control unit as an external power source.

In some embodiments, the present disclosure may provide the following benefits:

Single Vehicle Operation: A single truck pulling multiple trailers can reduce the number of vehicles on the road, which helps in reducing traffic congestion and optimizing city routes. Fewer trucks also mean lower operational costs in terms of fuel, maintenance, and parking.

Sustainability: The system uses clean, renewable energy sources (solar and wind) to power the Semi-Trailer Unit, reducing emissions and reliance on fossil fuels.

Cost Savings: The ability to generate power from renewable sources reduces operational costs, and net metering can provide financial compensation and revenue streams for surplus energy.

Modular Capacity: The system would allow flexible scaling depending on the required load. More trailers can be added as needed, increasing cargo capacity without the need for a more powerful tractor.

Reduced Need for Overpowered Tractors: The combined propulsion from the tractor and its Trailers reduces the need for a massively overpowered tractor, as each trailer contributes to the propulsion

Lower Labor & Operational Costs: Mass deliveries to one city, different locations with one tractor.

Simplified Scheduling and Fleet Management: A single vehicle (with multiple trailers) to manage simplifies fleet coordination, reducing the complexity of dispatching and maintenance schedules.

More Consistent Delivery Times & Centralized Control: With one vehicle handling all the deliveries, it's easier to synchronize delivery times and optimize routes. For example, a dedicated truck pulling trailers can follow a set route with planned stops, ensuring deliveries happen within time windows without the delays caused by coordinating multiple vehicles.

Wireless EV Charging: The wireless EV charging system offers a convenient and efficient way to charge electric vehicles, reducing the need for traditional charging infrastructure.

Autonomous Propulsion Support: The system allows the trailers to propel themselves and push others when required using its renewable energy, with the tractor acting as a guide vehicle for navigation and steering.

Energy Efficiency: The energy management system ensures that energy is used efficiently, reducing waste and improving the overall performance of the vehicle.

Power Generators on the Go: Trailer Units parked at the dock shall act as power generators for the time the unit is parked at a rest area or docked, sharing utilities Burdon in peak hours.

Saving Engine Idling Cost: The unit can harness energy to power auxiliary systems such as air conditioning, lighting, and refrigeration units without relying on the truck's main engine. This would minimize fuel consumption and emissions during long stops, rest periods, or while waiting in traffic. The system shall save idle engine diesel, causing carbon emissions, and save at least thousands of dollars to the owners per month. Big fleets of thousands can save million Dollars and carbon credits.

Autonomy: The power system allows for extended operations without requiring access to traditional refueling infrastructure.

Mobility: The compact system is designed for easy adaptation to existing semi-trailer setups, offering a mobile renewable energy solution.

Convenience: Wireless EV charging simplifies the process of powering electric vehicles and reduces dependency on physical connectors.

Energy Efficiency: Integration of renewable energy systems reduces dependency on external charging infrastructure.

Operational Autonomy: The unit’s ability to move independently streamlines logistics and reduces reliance on tractor units.

Safety: Advanced navigation and collision-avoidance systems ensure safer operation in various environments.

Environmental Impact: Reduced emissions through renewable energy usage and electrification.

### Preserving Human Employment in Autonomous Logistics

Unlike fully autonomous systems that eliminate truck driving jobs, this invention allows human operators to work remotely, controlling multiple trailers from a command center.

Skilled operators remain essential for managing fleets, troubleshooting issues, and ensuring safe deliveries.

### Flexible Work Arrangements for Drivers

Operators can control trailer units from their home or office, reducing the need for long-haul trips that take drivers away from their families for weeks.

Drivers can choose shifts on demand, working flexible hours instead of adhering to rigid schedules.

### Increased Safety & Reduced Fatigue

Remote operation eliminates driver fatigue from long, continuous trips, reducing road accidents caused by exhaustion.

The humanoid robot ensures real-time human oversight, reducing the risk of AI-only decision-making failures.

### Scalability & Efficiency in Freight Transport

A single operator can remotely control multiple trailers moving between warehouses and distribution centers.

The system allows autonomous convoys, where a humanoid-operated lead trailer guides a train of self-propelled trailers, optimizing road space and reducing congestion.

### Seamless Integration with Existing Trucking Infrastructure

Traditional trucks and logistics companies can adopt this without replacing their entire fleet, enabling gradual adoption of automation.

The humanoid robot can interact with both digital systems (for EV trailers) and mechanical controls (for conventional diesel tractors), ensuring smooth hybrid operations

### Cost Savings for Logistics Companies

Reduced reliance on full-time, long-haul drivers cuts labor costs while still maintaining human control.

More efficient trailer utilization (through remote operation and fleet coordination) leads to higher transport capacity with fewer resources.

### Faster Deployment of Autonomous Logistics

Unlike fully autonomous truck technology that requires extensive regulatory approvals, this system retains a human-in-the-loop, expediting regulatory acceptance and real-world deployment.

In some embodiments, the present disclosure may comprise the following aspects:

1. A method for retrofitting existing semi-trailer units into autonomous, self-driven electric vehicles, comprising:

Installing 2 EV DC motors in the rear wheels for propulsion;

Adding a steering mechanism to the front wheels for maneuverability.

Equipping the unit with a lithium battery pack beneath the trailer frame.

Integrating control systems for autonomous navigation and propulsion.

Integrating control systems for in combination tractor navigation and steering.

2. A semi-trailer unit equipped with renewable energy systems, including:

Solar paint for harvesting solar energy;

Compact high-efficiency wind turbines for generating electricity during motion;

An energy management system for the optimum benefits of energy distribution.

3. A system for autonomous operation, comprising:

LiDAR, cameras, and ultrasonic sensors for navigation and safety;

Advanced braking, collision avoidance, and lane-assist features;

A centralized control unit for autonomous decision-making.

4. A humanoid robot interface for controlling trailer trains, comprising:

A wireless communication network for receiving operator commands;

Physical and digital interfaces for steering and braking;

Real-time monitoring of trailer status and synchronization.

5. A wireless inductive charging system, comprising:

Inductive charging plates beneath the trailer;

Stationary charging pads at designated locations;

A mechanism for efficient energy transfer via electromagnetic fields.

6. The system of aspect 1, wherein the net metering system tracks the energy generated and exported to the grid, providing credits to the operator of the semi-trailer.

7. The system of aspect 1 further comprises a centralized control system that monitors energy generation, consumption, and propulsion coordination between the trailer and tractor.

The present disclosure provides a groundbreaking approach to transforming conventional semi-trailer units into self-sufficient, autonomous EV systems, paving the way for more efficient and sustainable transportation solutions.

The present disclosure transforms conventional semi-trailer units into autonomous, self-driven electric vehicles (EVs) equipped with renewable energy systems and advanced control features. These modified trailers:

1. Operate independently or in combination with a tractor, moving between locations with or without requiring a tractor unit.

2. Propels the tractor unit when connected, using its onboard electric motors to provide propulsion, while the tractor primarily serves as a steering and navigation platform.

3. Enable renewable energy harvesting through integrated solar paint and high efficiency compact wind turbines.

4. Support net metering, where excess energy generated by the trailer’s renewable systems can be fed back into the grid when parked at designated facilities, providing a two-way energy flow.

5. Enhance safety and efficiency through advanced navigation and collision-avoidance systems.

6. Support synchronized operation in a convoy ("train" of trailers) with or without a tractor.

7. Introduce a novel wireless inductive charging system for seamless energy replenishment at rest areas or docks.

8. Allow a single operator to remotely manage multiple trailer units, improving logistics, reducing operator strain, and enhancing flexibility.

The invention achieves its objectives through a combination of innovative propulsion, renewable energy integration, and autonomous technologies:

Trailer Propulsion for Tractor: When connected to a tractor unit, the trailer’s electric motors actively provide propulsion. The tractor primarily handles steering, navigation, and communication with other trailers, reducing its mechanical load and fuel consumption.

Autonomous Propulsion: When operating independently, the trailer’s electric motors power the unit, enabling self-driven movement.

Steering Mechanism: Trailer’s Front wheels are equipped with remote-controlled actuators that provide precise maneuverability.

Renewable Energy Systems: Solar paint and wind turbines harvest energy to recharge the onboard huge battery pack, reducing reliance on external power sources.

Navigation and Control: LiDAR, cameras, and sensors monitor the environment for real-time mapping, navigation, and safety.

Communication: Wireless interfaces enable remote control by a human operator or coordination with a tractor’s control systems.

Wireless Inductive Charging: Electromagnetic charging pads allow for efficient and hands-free battery recharging.

Remote Operation: Trailers can be monitored and controlled by a single operator who can manage logistics and coordination across multiple units from a remote location.

Humanoid Robot: In train configurations, a robot in the lead trailer executes operator commands for seamless coordination of multiple units.

In some embodiments, the present disclosure may include the following components:

1. Electric Propulsion System:

Two EV DC motors are integrated into the rear wheels to provide propulsion.

Lithium-ion battery pack mounted beneath the trailer frame.

2. Steering and Navigation System:

Two additional front wheels with independent suspension and remote-controlled actuators for steering.

When connected to a tractor, the trailer’s propulsion system integrates with the tractor's steering and navigation system to create a unified driving experience.

3. Renewable Energy Systems:

Solar paint applied to the trailer frame for photovoltaic energy harvesting.

Compact wind turbines are installed on the roof and edges of the trailer to generate power during transit.

4. Safety and Navigation Systems:

LiDAR sensors for 3D mapping and obstacle detection.

Cameras and ultrasonic sensors for additional environmental data.

Lane-assist, collision-avoidance, and adaptive braking systems.

5. Wireless Inductive Charging System:

Charging plates beneath the trailer.

Dock-installed electromagnetic pads for hands-free charging. Mechanical charging is additional.

6. Humanoid Robot Interface (For Trailer Trains):

A robot capable of simulating operator actions for control.

Wireless communication system for receiving operator commands.

Interfaces for managing trailer synchronization and system monitoring.

7. Control System and Interfaces:

Centralized onboard computer for navigation, propulsion, and energy management.

Integrated switches to toggle between diesel-powered tractor control and EV trailer control.

In some embodiments, the present disclosure may include the following steps:

1. Preparation and Retrofitting:

Install electric motors, steering mechanisms, and renewable energy systems on existing semi-trailers.

Add safety and navigation components, including LiDAR, cameras, and sensors.

Configure wireless inductive charging systems and communication interfaces.

2. Operational Steps for Independent Trailer Use:

Activate the autonomous control system via a remote interface.

Use onboard navigation to guide the trailer to its destination.

Recharge the battery via renewable energy systems or wireless / wired charging stations as needed.

3. Operational Steps for Trailer and Tractor Combination:

Connect the trailer to a tractor unit.

The trailer’s propulsion system actively pushes the tractor, reducing the tractor’s fuel consumption.

The tractor acts as the primary steering and navigation platform, transmitting directional commands to the trailer.

Communication between the tractor and trailer ensures synchronized braking, acceleration, and navigation.

4. Operational Steps for Trailer Trains:

Connect multiple trailers to a tractor.

Establish communication between the tractor and trailers.

Use the humanoid robot to simulate operator commands, synchronizing trailer propulsion, braking, and steering.

5. Control and Navigation:

Monitor the environment through cameras installed in the robot head, sensors, and adjust propulsion and steering accordingly.

Engage safety systems like adaptive braking and collision avoidance when required.

In some embodiments, the components may be arranged in the following manner:

Chassis and Renewable Energy Systems:

Solar paint covers the trailer’s outer surface for optimal photovoltaic energy capture.

Compact wind turbines are positioned to capture airflow during transit. The energy management system optimizes usage between the onboard battery and the net metering interface.

Energy Storage and Net Metering Interface:

The lithium battery pack stores harvested energy, while a bidirectional inverter manages energy flow between the trailer and external systems, enabling grid interaction.

Wheel Assemblies: Rear wheels incorporate in-wheel electric motors for propulsion. The front axle accommodates the steering mechanism for precise control.

Energy Systems: Renewable energy sources (solar and wind) feed into the energy management unit, which optimizes distribution to the propulsion system and other onboard electronics.

Trailer and Tractor Integration: When connected to a tractor, the trailer’s propulsion system assists or fully propels the tractor, minimizing mechanical strain on the tractor. The tractor communicates steering and navigation commands to the trailer for synchronized operation.

Navigation and Control Systems: Sensors and cameras are positioned around the trailer for comprehensive environmental monitoring. Data is processed by a central control unit to enable autonomous navigation and safety features.

Humanoid Robot Interface: Located in the lead tractor of a trailer train configuration, the robot serves as the central command executor, relaying operator instructions to all trailers and ensuring coordinated operation.

This arrangement enables the invention to redefine the conventional tractor-trailer dynamics, achieving an unprecedented level of efficiency, sustainability, and operational flexibility.

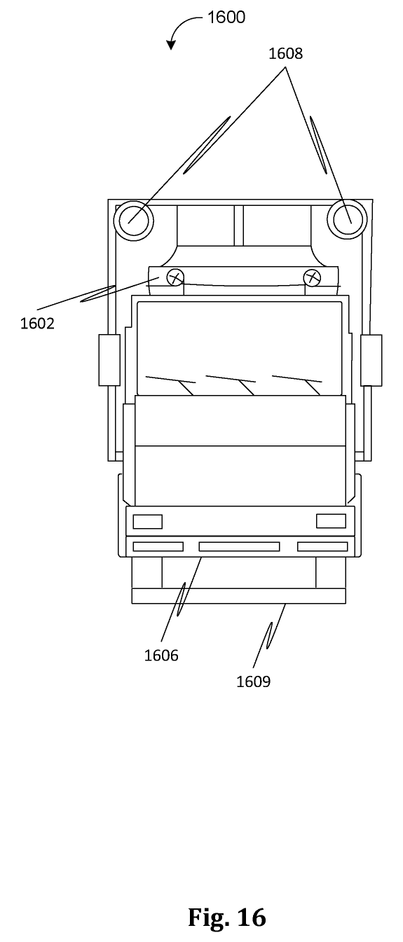

In accordance with FIGS. 16-20, the component labels include:

Thin Film Transparent Solar sheet, Solar Panels, Solar paint – 1601;

1000-watt Wind Turbines assembly coupled with a generator – 1602;

Battery Storage Bank under the chassis – 1603;

DC Power Motors coupled with Rear Wheels – 1604;

Autonomous Tractor unit EV coupled via Control Modules – 1605;

EV Wireless Charging System – 1606;

EV Charging Port – 1607;

High Speed Wind Turbines – 1608;

Wireless charging Underlayment – 1609.

Further, in some embodiments, a self-propelled energy-harvesting trailer system may be configured for facilitating autonomous movement of a semi-trailer. Further, the self-propelled energy-harvesting trailer system may include and/or may be the apparatus. Further, the self-propelled energy-harvesting trailer system may comprise a trailer body. Further, an energy harvesting device may be attached to the trailer body. Further, the energy harvesting device may be configured for generating electrical energy from an external energy source. Further, an energy storage device may be connected to the energy harvesting device. Further, the energy storage device may be configured for storing the electrical energy. Further, a propulsion device may be attached to the trailer body and may be operatively coupled to the energy storage device. Further, the propulsion device may include the propulsion assemblies. Further, the propulsion device may be configured for converting the electrical energy into mechanical motion to propel the trailer body. Further, a control device may be communicatively coupled to the propulsion device. Further, the control device may be configured for generating a propulsion control signal to control operation of the propulsion device. Further, the control device may include the processing device.

In some embodiments, the self-propelled energy-harvesting trailer system may include the energy harvesting device comprising a solar paint layer coated on an exterior surface of the trailer body. Further, the solar paint layer may be configured for converting incident sunlight into the electrical energy.

In some embodiments, the self-propelled energy-harvesting trailer system may include the energy harvesting device comprising a thin-film photovoltaic panel affixed to the trailer body. Further, the thin-film photovoltaic panel may be configured for generating the electrical energy under diffuse light conditions.

In some embodiments, the self-propelled energy-harvesting trailer system may include the energy harvesting device comprising a wind turbine positioned on the trailer body. Further, the wind turbine may be configured for generating the electrical energy in response to airflow generated by movement of the trailer body.

In some embodiments, the self-propelled energy-harvesting trailer system may include the energy storage device being further configured for delivering the electrical energy to the propulsion device during a time interval in which the energy harvesting device is inactive.

In some embodiments, the self-propelled energy-harvesting trailer system may include the propulsion device being further configured for enabling self-propelled movement of the trailer body in the absence of mechanical towing by a tractor unit.

In some embodiments, the self-propelled energy-harvesting trailer system may include the propulsion device being further configured for transmitting mechanical torque directly to a wheel mounted on the trailer body.

In some embodiments, the self-propelled energy-harvesting trailer system may include the control device being further configured for regulating an operating state of the propulsion device based on a predefined propulsion parameter.

In some embodiments, the self-propelled energy-harvesting trailer system may include the control device being further configured for adjusting an output level of the propulsion device in response to a stored energy level of the energy storage device.

In some embodiments, the self-propelled energy-harvesting trailer system may include the energy storage device being mounted beneath the trailer body. Further, mounting the energy storage device beneath the trailer body may be configured for lowering a center of gravity of the trailer system.

In some embodiments, the self-propelled energy-harvesting trailer system may include the propulsion device being further configured for enabling controlled maneuvering of the trailer body during a docking operation or a parking operation.

In some embodiments, the self-propelled energy-harvesting trailer system may include the energy harvesting device being further configured for continuously supplying the electrical energy to the energy storage device during movement of the trailer body.

In some embodiments, the self-propelled energy-harvesting trailer system may include the propulsion device being further configured for generating reduced propulsion force to enable precision movement of the trailer body.

In some embodiments, the self-propelled energy-harvesting trailer system may include the control device being further configured for initiating activation of the propulsion device in response to a propulsion command signal.

In some embodiments, the self-propelled energy-harvesting trailer system may include the energy storage device being further configured for supplying the electrical energy to maintain readiness of the propulsion device while the trailer body is stationary.

In some embodiments, the self-propelled energy-harvesting trailer system may include the energy harvesting device being further configured for reducing dependency on an external electrical charging source during trailer operation.

In some embodiments, the self-propelled energy-harvesting trailer system may include the energy harvesting device being further configured for generating the electrical energy while the trailer body remains parked.

In some embodiments, the self-propelled energy-harvesting trailer system may include the propulsion device being further configured for propelling the trailer body along a longitudinal axis of the trailer body.

In some embodiments, the self-propelled energy-harvesting trailer system may include the control device being further configured for inhibiting operation of the propulsion device when an energy level of the energy storage device falls below a predefined threshold.

In some embodiments, the self-propelled energy-harvesting trailer system may include coordinated operation of the energy harvesting device, the energy storage device, and the propulsion device, enabling sustained autonomous propulsion of the trailer body over an operational duration.

In some embodiments, the disclosed self-propelled energy-harvesting trailer system may provide a technical improvement in the field of electric vehicle propulsion systems by enabling a trailer unit to generate, store, and utilize electrical energy independently of an external towing vehicle. A technical problem addressed by this improvement is the conventional dependency of trailers on tractor-supplied propulsion and power, which limits operational flexibility and increases energy inefficiency. In some embodiments, this improvement may be implemented by physically integrating an energy harvesting device directly onto a trailer body and electrically coupling the energy harvesting device with an onboard energy storage device and a propulsion device. By locating the propulsion capability within the trailer itself, the system may reduce drivetrain losses associated with tractor-trailer power transmission and may enable propulsion to be applied closer to the point of load, thereby improving propulsion efficiency and traction control.

In some embodiments, the invention may provide a technical improvement in renewable energy harvesting technology by enabling concurrent harvesting of multiple ambient energy sources directly from a mobile trailer platform. A technical problem addressed by this feature is the intermittency and low energy density of single-source renewable harvesting in mobile environments. In some embodiments, this improvement may be implemented by configuring the energy harvesting device to include at least one solar-based harvesting mechanism and at least one motion-induced harvesting mechanism, such as a wind-responsive generator, each physically mounted on different regions of the trailer body. For example, solar paint or thin-film photovoltaic layers may be applied to exterior trailer surfaces to capture diffuse and direct sunlight, while compact wind turbines may be positioned in airflow-optimized regions to convert kinetic energy generated during movement. This combination may improve the overall energy yield per unit surface area, thereby enhancing the efficiency of mobile renewable energy systems.

In some embodiments, the invention may provide a technical improvement in distributed energy storage integration for mobile platforms by positioning an energy storage device beneath the trailer body in direct electrical proximity to both the energy harvesting device and the propulsion device. A technical problem addressed by this improvement is the inefficiency and instability caused by remote or poorly distributed energy storage in large vehicle assemblies. In some embodiments, the energy storage device may include a modular battery pack physically mounted to the trailer chassis and electrically connected using short-path conductors to minimize resistive losses. This configuration may improve power delivery stability, reduce thermal buildup in conductors, and enable scalable energy storage capacity tailored to trailer size and load requirements.

In some embodiments, the invention may provide a technical improvement in propulsion control technology by using a control device configured to generate propulsion control signals based on internal system conditions rather than relying solely on external vehicle commands. A technical problem addressed is the lack of autonomous propulsion intelligence at the trailer level in conventional vehicle systems. In some embodiments, the control device may be implemented as an onboard electronic control unit that monitors energy availability, propulsion demand, and the operational state of the trailer and generates propulsion control signals accordingly. This may allow the trailer to regulate its own propulsion output, reduce energy waste, and prevent over-discharge of the energy storage device, thereby improving the reliability of electric propulsion systems.

In some embodiments, the invention may provide a technical improvement in vehicle maneuverability technology by enabling low-speed, precision movement of a trailer independently of a tractor unit. A technical problem addressed by this improvement is the difficulty of maneuvering trailers during docking, staging, or parking operations using conventional towing mechanisms. In some embodiments, the propulsion device may be configured to deliver controlled torque at low rotational speeds to one or more wheels mounted on the trailer body. This may enable fine positional adjustments of the trailer without requiring tractor repositioning, thereby improving operational efficiency in constrained environments such as loading docks or warehouses.

In some embodiments, the invention may provide a technical improvement in energy autonomy technology for freight transport systems by enabling sustained trailer operation even when external energy harvesting is temporarily unavailable. A technical problem addressed is the interruption of electric propulsion due to environmental variability. In some embodiments, the energy storage device may be configured to supply stored electrical energy to the propulsion device during periods of low or no energy harvesting, such as nighttime or stationary conditions. This may improve operational continuity and reliability of renewable-powered transportation systems.

In some embodiments, the invention may provide a technical improvement in structural-energy integration technology by distributing energy harvesting elements across load-bearing and non-load-bearing surfaces of the trailer body. A technical problem addressed is the inefficient use of available surface area in conventional trailer designs. In some embodiments, solar harvesting layers may be applied to flat exterior panels, while wind harvesting components may be integrated into structural recesses or aerodynamic features. This approach may allow energy harvesting to be integrated without compromising structural integrity or cargo capacity, thereby improving overall system utility.

In some embodiments, the invention may provide a technical improvement in mobile power generation technology by enabling a trailer to generate electrical energy while stationary. A technical problem addressed is the inability of conventional trailers to contribute to energy generation when parked. In some embodiments, the energy harvesting device may continue generating electrical energy from ambient sources such as sunlight or wind while the trailer body remains stationary, and the generated energy may be stored in the energy storage device. This capability may improve energy utilization efficiency and support auxiliary power needs without additional infrastructure.

In some embodiments, the invention may further include an advanced energy management module that improves the technology of energy optimization in electric vehicle systems. A technical problem addressed is the inefficient allocation of harvested energy between propulsion and storage. In some embodiments, the energy management module may dynamically prioritize energy flow based on operational conditions, such as directing harvested energy directly to the propulsion device during movement or preferentially charging the energy storage device during idle periods. This may improve overall system efficiency and extend operational range.

In some embodiments, the invention may include an adaptive propulsion modulation feature that improves propulsion efficiency technology. A technical problem addressed is excessive energy consumption during uniform propulsion. In some embodiments, the control device may adjust propulsion output based on trailer load, terrain inclination, or operational mode. For example, reduced propulsion output may be applied during low-load conditions, while increased output may be enabled during incline traversal. This may reduce unnecessary energy expenditure and improve propulsion system longevity.

In some embodiments, the invention may include a thermal regulation feature that improves battery safety and longevity technology. A technical problem addressed is the thermal degradation of energy storage devices during high-load operation. In some embodiments, passive or active thermal management elements may be integrated with the energy storage device to dissipate heat generated during charging or propulsion. This may include heat-spreading structures or controlled airflow paths integrated into the trailer body, thereby improving energy storage reliability.

In some embodiments, the invention may include a modular energy harvesting architecture that improves scalability technology for renewable energy systems. A technical problem addressed is the difficulty of adapting fixed energy harvesting configurations to different trailer sizes or use cases. In some embodiments, the energy harvesting device may be constructed from interchangeable modules that can be selectively installed or removed. This may allow the energy harvesting capacity to be scaled according to operational requirements, thereby improving system adaptability.

In some embodiments, the invention may include an autonomous readiness preservation feature that improves standby efficiency technology. A technical problem addressed is energy loss during prolonged stationary periods. In some embodiments, the control device may place the propulsion device and associated electronics into a low-power state while maintaining sufficient readiness for rapid activation. This may reduce parasitic energy losses and improve long-term energy retention in the energy storage device.

In some embodiments, the invention may include a coordinated multi-trailer energy utilization feature that improves convoy-level energy management technology. A technical problem addressed is inefficient energy use across multiple trailers operating in proximity. In some embodiments, multiple trailer systems may share operational data to coordinate propulsion timing or energy usage patterns, thereby reducing redundant energy expenditure and improving overall transportation efficiency.

In some embodiments, a vehicle propulsion system may comprise a semi-trailer including a structural chassis. Further, at least one electrically driven propulsion motor may be mechanically coupled to at least one-wheel axle of the semi-trailer. Further, an onboard electrical energy storage assembly may be physically mounted to the chassis of the semi-trailer. Further, at least one renewable energy harvesting assembly may be physically mounted to the semi-trailer and may be electrically coupled to the energy storage assembly. Further, a plurality of sensors may be mounted to the semi-trailer. Further, the plurality of sensors may be configured to detect one or more of vehicle motion, environmental conditions, and obstacles. Further, a trailer-resident electronic control unit (ECU) may be electrically coupled to the propulsion motor, the energy storage assembly, the renewable energy harvesting assembly, and the plurality of sensors. Further, the trailer-resident ECU may be configured for generating propulsion torque commands for the semi-trailer based on sensor data. Further, the trailer-resident ECU may be configured for regulating energy flow between the renewable energy harvesting assembly and the energy storage assembly. Further, the trailer-resident ECU may be configured for transmitting coordinated motion control signals to a tractor unit mechanically coupled to the semi-trailer. Further, the semi-trailer may provide tractive propulsion independently of, or in assistance to, the tractor unit during vehicle operation.

In some embodiments, a method of operating a semi-trailer may comprise receiving, at an electronic control unit mounted on the semi-trailer, sensor data indicative of vehicle motion and a surrounding environment. Further, the method may comprise computing, at the electronic control unit, propulsion torque commands for electric motors mounted to the semi-trailer. Further, the method may comprise delivering tractive force to the wheels of the semi-trailer independently of a tractor engine. Further, the method may comprise transmitting synchronization signals from the semi-trailer to a tractor unit. Further, the synchronization signals may be configured to coordinate one or more of the braking actions and steering actions. Further, the method may comprise selectively operating the semi-trailer in a self-propelled mode or a tractor-assisted propulsion mode based on detected operating conditions.

In some embodiments, the trailer-resident ECU is configured for determining a propulsion output based on a predicted energy availability value.

In some embodiments, the predicted energy availability value is calculated using at least one of solar irradiance data, wind velocity data, terrain gradient data, or vehicle load data.

In some embodiments, a plurality of additional semi-trailers is mechanically coupled in series. Further, each semi-trailer of the plurality of additional semi-trailers may include a respective propulsion motor and a respective control unit.

In some embodiments, the trailer-resident ECUs are configured for exchanging propulsion load information. Further, the trailer-resident ECUs may be configured for dynamically allocating tractive force among the semi-trailers.

In some embodiments, a robotic actuation assembly is positioned within a tractor cabin.

In some embodiments, the robotic actuation assembly is configured for physically actuating at least one mechanical control of the tractor selected from a steering control, a braking control, or a throttle control.

In some embodiments, the robotic actuation assembly is configured for converting electronic command signals into mechanical movements. Further, the mechanical movements may correspond to human control inputs.

In some embodiments, the trailer-resident ECU is configured for detecting abnormal thermal conditions within the energy storage assembly.

In some embodiments, the ECU is configured for initiating an automated safety response. Further, the automated safety response may comprise at least one of reducing propulsion output, disengaging the semi-trailer from a coupled convoy, or navigating the semi-trailer to a predefined isolation location.

In some embodiments, the energy storage assembly is electrically coupled to an external power system while the semi-trailer is stationary.

In some embodiments, the electrical energy is selectively transferred between the energy storage assembly and the external power system. Further, the selective transfer of electrical energy may be under the control of the trailer-resident ECU.

In some embodiments, an inductive power transfer interface is mounted to the semi-trailer.

In some embodiments, the inductive power transfer interface is configured for exchanging energy with a stationary charging surface. Further, the exchanging of energy may occur when the semi-trailer is positioned above the charging surface.

In some embodiments, an apparatus for facilitating movement of one or more trailers includes one or more trailers, each having a respective trailer body (e.g., a semi-trailer frame, chassis, or structural shell that supports cargo and axle assemblies). Further, one or more energy harvesting devices are coupled to the trailer body, where “coupled” includes being mounted, bonded, bolted, riveted, welded, or otherwise physically attached, and where the energy harvesting devices convert ambient energy present in an environment into electrical energy. As used herein, “environment” includes ambient sunlight, ambient airflow/wind, and/or an electromagnetic field produced by a stationary inductive charging surface, and “electrical energy” includes electrical power in direct current (DC) or alternating current (AC) form that can be conditioned for storage or propulsion. In one example, the energy harvesting devices include photovoltaic structures such as solar paint coatings, thin-film photovoltaic laminates, or transparent film photovoltaic cells disposed on exterior trailer surfaces; in another example, the energy harvesting devices include one or more wind turbines and associated generators mounted on the roof, edge, or forward regions of the trailer to convert airflow into electrical power. Further, one or more energy storage devices are coupled to the trailer body and electrically coupled with the energy harvesting devices, where “energy storage device” includes one or more battery packs (e.g., lithium-ion, lithium iron phosphate), supercapacitors, or hybrid battery-capacitor banks, optionally including a battery management system (BMS), contactors, fuses, and voltage/current/temperature sensing. Further, one or more trailer propulsion assemblies are coupled to the trailer body and operatively coupled with one or more wheels mounted on the trailer body, where “operatively coupled” means mechanically linked to transmit torque to a rotating wheel or axle (directly or via a gearbox/differential). In example implementations, a trailer propulsion assembly includes an in-wheel motor, an axle-mounted electric motor coupled through a gear reduction, and/or an e-axle module, together with an inverter/motor driver and optional torque and wheel-speed sensing. Further, the trailer propulsion assemblies drive the wheels using one or more driving characteristics, where “driving characteristics” are defined as controllable wheel-motion parameters including commanded wheel torque, wheel speed, direction (forward/reverse), acceleration ramp rate, braking torque (including regenerative braking), and/or traction-control modulation. Further, the trailers are maneuverable, where “maneuverable” means capable of controlled changes in position and/or heading using at least propulsion and braking control and, in some embodiments, steering control, including low-speed positioning such as docking or parking. Further, a processing device is operatively coupled with the trailer propulsion assemblies, the energy storage devices, and the energy harvesting devices, where “processing device” is defined structurally as one or more processors (e.g., microcontroller, central processing unit (CPU), or system-on-chip (SoC)), memory storing executable instructions, and input/output (I/O) circuitry (e.g., Controller Area Network (CAN), Local Interconnect Network (LIN), Ethernet, pulse-width modulation (PWM), analog I/O) interfacing with the inverter, BMS, and harvesting power-conditioning components (e.g., charge controller, rectifier, direct-current-to-direct-current (DC-to-DC) converter). In some embodiments, the processing device generates one or more commands for controlling at least one movement of the trailers, where “commands” include torque commands, speed setpoints, braking commands, steering setpoints, and/or power-routing commands. In one example control flow, the processing device determines a target wheel torque based on a requested speed and battery state-of-charge and then outputs inverter current references as commands; as a result, driving of the wheels with the driving characteristics using electrical energy (stored and/or harvested) is performed based on the commands. Further, in some embodiments, the trailer propulsion assemblies are mounted at rear wheel locations as high-torque electric motors and are powered by an onboard lithium battery pack mounted beneath the trailer frame to lower a center of gravity and improve stability. Further, the processing device may cooperate with an energy management unit that directs harvested energy to charge the energy storage device during idle periods and, during motion, selectively directs harvested energy to propulsion and/or charging to reduce reliance on external charging stations. Further, in some embodiments, the trailer propulsion assemblies provide tractive propulsion in a self-propelled mode when a tractor is absent and provide propulsion-assist when a tractor is coupled, such that the trailer contributes propulsion while the tractor primarily provides steering and navigation. Further, in some embodiments, regenerative braking is implemented by commanding the propulsion motor(s) to produce braking torque while converting kinetic energy into electrical energy for storage in the energy storage device. Further, in some embodiments, a thermal safety subsystem is integrated with the energy storage device, including temperature sensors and a containment structure (e.g., a thermal blanket assembly) to mitigate thermal events, and the processing device inhibits propulsion output or enters a safe mode responsive to abnormal thermal conditions.

In some embodiments, one or more wheels are mounted to a rear portion of a trailer body, where “rear portion” refers to a region closer to the rear end of the trailer relative to the trailer’s longitudinal axis. Further, the trailer includes one or more steerable wheels mounted to a front portion of the trailer body, where “front portion” refers to a region closer to the front end of the trailer relative to the longitudinal axis, and “steerable wheels” are defined as wheels whose steer angle is adjustable relative to the trailer body to change trailer heading. Further, the apparatus includes one or more steering assemblies coupled to the trailer body and configured to steer the steerable wheels based on the commands generated by the processing device. As used herein, a “steering assembly” includes structural components such as an electric steering actuator (e.g., servo motor or linear actuator), a steering linkage (e.g., rack-and-pinion, tie rods, knuckle arms), and one or more steering sensors (e.g., encoder or potentiometer) with a steering controller/driver. In one example, the processing device outputs a target steer angle and a rate limit, and the steering assembly actuates the steerable wheels to that angle. In some embodiments, the trailer is maneuvered based on the steering of the steerable wheels, including executing turns, aligning to a dock face, and performing low-speed path corrections while coordinating propulsion torque and braking. Further, in some embodiments, the steerable wheels are implemented as additional front wheels with independent suspension and dedicated electric actuators to enable precise turning and low-speed docking maneuvers. Further, in some embodiments, steering commands are generated for each trailer in a coupled “train” configuration so that each trailer can steer in synchronization with an overall trajectory, thereby reducing off-tracking during turns. Further, in some embodiments, the steering assembly supports remote steering by converting received steering-angle setpoints into actuator movement while enforcing mechanical limits and safe rate-of-change limits to reduce jackknifing risk.

In some embodiments, the processing device is configured for analyzing one or more movement data and determining one or more movement characteristics for at least one movement associated with the trailers, where the commands are further based on the movement characteristics. As used herein, “movement data” is defined as time-indexed data representing motion-related signals, including one or more of trailer speed, wheel speeds, yaw rate, acceleration, articulation angle, steering angle, braking status, obstacle proximity, grade/terrain estimate, and/or operator-requested setpoints. As used herein, “analyzing” includes filtering, fusing, and evaluating the movement data using one or more deterministic computations (e.g., threshold checks, model-based estimation, kinematic calculations, and/or table-based control laws). As used herein, “movement characteristics” are computed control parameters derived from the analysis, including one or more of target acceleration, target deceleration, target yaw rate, target curvature, maximum allowable torque, maximum docking speed, traction limit, or stability limit. In one example, the processing device computes a movement characteristic as a maximum allowable wheel torque based on wheel-slip estimation and a minimum battery state-of-charge reserve, and then generates torque and braking commands bounded by that computed limit. Further, in some embodiments, the movement characteristics include a selectable operating mode characteristic indicating a self-propelled mode or a tractor-assisted propulsion mode, where the processing device adjusts propulsion torque contribution based on detected operating conditions. Further, in some embodiments, the processing device computes a predicted energy availability value using measurable inputs including solar irradiance, wind velocity, terrain gradient, and vehicle load, and determines movement characteristics (e.g., torque ceilings or duty cycles) based on the predicted energy availability value. Further, in some embodiments, movement characteristics include brake blending targets that distribute commanded braking between friction brakes and regenerative braking, thereby improving energy recovery while meeting stopping requirements.

In some embodiments, the apparatus further includes one or more sensors coupled to the trailer body and communicatively coupled with the processing device, where the sensors detect one or more parameters associated with trailer movement and the processing device generates movement data based on the detected parameters. As used herein, “sensor” includes light detection and ranging (LiDAR), camera, ultrasonic sensor, radar, inertial measurement unit (IMU) (accelerometer/gyroscope), wheel-speed sensor, steering-angle sensor, Global Positioning System (GPS) receiver, torque sensor, load sensor, and/or environmental sensors such as wind and irradiance sensors. As used herein, “parameters” include measurable physical quantities such as distance-to-obstacle, lane boundary position, trailer speed, wheel speed, acceleration, yaw rate, steering angle, brake pressure, ambient wind velocity, and solar irradiance. In an example implementation, LiDAR and cameras detect obstacles and lane geometry, an IMU provides yaw/acceleration, and wheel-speed sensors provide wheel rotational speed; the processing device time-aligns these parameter readings, generates movement data structures (e.g., state vectors and event flags), and analyzes the movement data to determine movement characteristics used to generate propulsion, braking, and steering commands. Further, in some embodiments, the sensors are installed at the front, side, and rear regions of the trailer body to provide all-around environmental awareness during autonomous movement and during docking operations. Further, in some embodiments, the processing device uses LiDAR data to generate a three-dimensional (3D) map of surrounding obstacles and combines the 3D map with camera-based lane and object cues and ultrasonic proximity cues to produce redundancy and improve safety. Further, in some embodiments, the processing device generates safety event flags based on sensor thresholds (e.g., obstacle within a distance threshold, lane departure risk, proximity alert) and uses the safety event flags to trigger automatic braking, collision avoidance responses, or speed limiting.

In some embodiments, one or more trailers are coupled with a tractor, where “tractor” refers to a powered towing vehicle mechanically connected to a semi-trailer via a coupling (e.g., fifth wheel/kingpin) and capable of providing steering and braking control interfaces. Further, the tractor includes one or more tractor controllers, where “tractor controller” includes an electronic control module and a controller (i.e., processor) that monitors and/or generates vehicle control signals (e.g., powertrain controller, brake controller, stability controller). Further, the apparatus includes a communication device communicatively coupled with the processing device and configured to receive movement data from the tractor controllers, where “communication device” includes physical transceiver hardware and protocol logic such as a Controller Area Network (CAN) transceiver, Ethernet interface, wireless modem, or other vehicle-network interface. In some embodiments, the received movement data is associated with one or more movement operations of the tractor, where “movement operations” include acceleration requests, braking requests, steering intent, stability events, and route adjustment signals. In one example, a tractor brake controller transmits brake demand and a tractor steering controller transmits steering angle over a CAN bus, and the trailer processing device uses those inputs to coordinate trailer propulsion torque and regenerative braking with the tractor’s motion operations. Further, in some embodiments, a centralized communication protocol links the tractor control systems to the trailer processing device so that the tractor transmits commands related to acceleration, braking, steering, and route adjustments while the trailer processing device transmits synchronization signals back to coordinate combined motion. Further, in some embodiments, the tractor primarily provides steering and navigation while the trailer propulsion assemblies actively provide propulsion-assist or tractive propulsion to reduce strain on the tractor engine and improve fuel efficiency.

In some embodiments, the tractor includes one or more tractor sensors communicatively coupled with the tractor controllers, where tractor sensors detect one or more actions performed on one or more physical interfaces of the tractor, and the tractor controllers generate movement data based on the detected actions. As used herein, “physical interfaces” include driver-actuated or robot-actuated controls such as a steering wheel, brake pedal, throttle pedal, gear selector, and parking brake control. As used herein, “actions” include measurable changes such as pedal displacement, pedal force, steering wheel rotation/torque, and switch state transitions. In one example, pedal position sensors and a steering angle sensor detect driver inputs, and the tractor controllers convert those sensor readings into movement data, including requested acceleration, requested braking level, and steering intent that is communicated to the trailer processing device for coordinated motion. Further, in some embodiments, a control adaptation unit intercepts signals from one or more physical interfaces and translates the signals into movement data suitable for commanding the trailer propulsion assemblies, such that pressing an accelerator in a selected mode results in a corresponding torque request for trailer propulsion. Further, in some embodiments, braking input is distributed between tractor friction brakes and trailer regenerative braking, and the tractor controllers generate movement data that includes brake blending information to support smooth, efficient deceleration.

In some embodiments, the tractor includes at least one robotic assembly and one or more physical interfaces, where the robotic assembly performs one or more actions on the physical interfaces and the tractor controllers generate movement data based on those performed actions. Further, the robotic assembly includes a humanoid robot and a robotic actuation assembly. As used herein, “robotic assembly” includes structural hardware such as one or more actuators (e.g., servo motors, stepper motors, linear actuators), mechanical linkages/end effectors (e.g., gripper, steering-wheel coupler, pedal pusher), and sensing (e.g., encoders, force sensors, cameras) arranged to physically manipulate the tractor’s mechanical controls. In one example, a robotic actuator rotates the steering wheel to a target angle and depresses the brake pedal to a target force, and the tractor sensors/controllers detect those inputs in the same manner as human inputs, thereby producing movement data that can be used by the trailer processing device for propulsion synchronization and coordinated braking/steering. Further, in some embodiments, the robotic assembly is positioned within a tractor cabin and is configured to actuate one or more mechanical controls, including a steering control, a braking control, and a throttle control. Further, in some embodiments, the robotic assembly converts electronic command signals into mechanical movements corresponding to human control inputs so that existing tractor interfaces can be used without requiring structural redesign of tractor controls. Further, in some embodiments, the robotic assembly includes one or more cameras, microphones, and speakers to support situational monitoring and remote operator interaction while performing physical actuation.

In some embodiments, the robotic assembly is configured for receiving one or more control commands from one or more external devices, and the robotic assembly performs actions on the tractor's physical interfaces based on those control commands. As used herein, “external device” includes a remote operator console, command-center workstation, fleet management computer, or other remote supervisory device. As used herein, “control commands” include target speed, target steering correction, braking level, mode selection, and emergency stop commands, and may be transmitted via a secure communication session (e.g., authenticated and/or encrypted wireless link). In one example, the external device transmits a target speed and steering correction via Wireless Fidelity (Wi-Fi) and/or cellular communication; the robotic assembly converts those commands into actuator trajectories (e.g., steering wheel rotation and pedal displacement profiles) with defined limits for maximum force, maximum rate, and safe stop behavior. Further, in some embodiments, an operator located at a control room transmits control commands wirelessly to the robotic assembly, and the robotic assembly executes the commands as physical inputs to tractor controls while also enabling synchronization with one or more trailer propulsion assemblies in a multi-trailer configuration. Further, in some embodiments, the robotic assembly relays operational status (e.g., braking status, steering position, fault events, obstacle warnings) back to the external device to enable real-time supervision, including issuing an emergency stop command responsive to detected hazards.

In some embodiments, the tractor further includes at least one tractor propulsion assembly, at least one tractor steering assembly, and a control assembly configured to transition between a first state and a second state. As used herein, a “tractor propulsion assembly” includes an engine and drivetrain or an electric traction motor and drivetrain capable of producing tractive force; a “tractor steering assembly” includes a steering column and steering actuator/linkage that changes tractor wheel direction; and a “control assembly” includes one or more mode-selection interfaces (physical switch, touchscreen control, or controller-controlled relay logic) and a control adaptation unit that routes interface signals and actuation authority according to the active mode. In some embodiments, at least one propulsion interface (e.g., throttle pedal sensor, torque request interface, or powertrain request line) actuates the tractor propulsion assembly in the first state, while at least one steering interface (e.g., steering wheel sensor/actuator command path) actuates the tractor steering assembly in each of the first and second states so that steering remains available in both modes. In one example, the first state corresponds to a tractor-driven propulsion mode using an internal combustion engine (ICE), and the second state corresponds to a trailer-assist or trailer-driven propulsion mode in which trailer propulsion assemblies supply at least part of the tractive effort while the tractor provides steering/navigation. In some embodiments, the tractor controllers generate one or more first movement data in the first state (e.g., engine torque request, transmission status, brake demand) and generate one or more second movement data in the second state (e.g., trailer-assist torque request, synchronization flags, brake blending commands), such that the movement data provided to the trailer processing device comprises the first movement data during the first state and comprises the second movement data during the second state. Further, in some embodiments, the mode-selection interfaces include physical and digital switches mounted in the tractor cabin that enable a transition between diesel propulsion control and an electric vehicle (EV) trailer propulsion-assist mode. Further, in some embodiments, the control adaptation unit translates accelerator and brake interface signals into trailer propulsion commands in the trailer propulsion-assist mode while maintaining tractor steering control in both modes. Further, in some embodiments, a cockpit display provides real-time information, including trailer battery status, energy consumption, and propulsion assist level settings to support safe state transitions and operator awareness.

In some embodiments, the apparatus includes a communication device communicatively coupled with the processing device, where the communication device receives one or more movement data from one or more external devices, and the processing device analyzes the received movement data to determine movement characteristics used for generating the commands. As used herein, “movement data from external devices” includes remote operator inputs (e.g., speed setpoints, steering corrections), mission-level directives (e.g., waypoints, docking target position), or safety constraints (e.g., geofenced speed limit, stop command). In one example, the processing device computes movement characteristics such as target curvature and maximum allowable docking speed from the received movement data, and then generates propulsion torque and steering commands to satisfy those characteristics while enforcing limits such as battery state-of-charge reserve and obstacle-based braking thresholds. Further, in some embodiments, the external devices include a fleet command center workstation that provides route preferences, delivery scheduling inputs, and remote control commands for one or more trailers, and the processing device uses such inputs to coordinate trailer movement between warehouses and distribution centers. Further, in some embodiments, the processing device enforces supervisory constraints received from the external device, including speed limits for specific facilities, restricted zones near loading docks, and emergency stop policies to improve operational safety.

In some embodiments, the one or more trailers include two or more trailers mechanically coupled in series, where each trailer includes a respective trailer body and respective wheel set, and “mechanically coupled in series” includes coupling via kingpin/fifth-wheel connections, drawbar hitches, dollies, or articulating couplers that transmit longitudinal forces while permitting articulation. Further, each trailer body carries a respective energy harvesting device, a respective energy storage device electrically coupled to the respective energy harvesting device, and a respective trailer propulsion assembly operatively coupled to the wheels of that trailer. In some embodiments, the controlling of movement includes controlling at least one movement of each trailer, and each trailer propulsion assembly independently drives its own wheels using electrical energy from its respective energy storage device based on commands. In one example, a lead processing device (or distributed processing devices) issues per-trailer torque setpoints and braking limits, and each trailer executes its setpoints locally using its inverter and motor driver while monitoring its own battery state-of-charge, temperature, and wheel-slip to maintain stable independent propulsion across the coupled series. Further, in some embodiments, the mechanically coupled trailers form a train configuration in which each trailer contributes propulsion so that the coupled assembly is not solely pulled by the tractor, and the trailers may actively propel the tractor under certain operating conditions. Further, in some embodiments, the processing devices of the trailers exchange propulsion load information and coordination signals so that the tractive effort is shared among trailers based on energy availability and load distribution.

In some embodiments, the processing device dynamically determines the driving characteristics for the wheels of each trailer body, where “dynamically” means updated during operation based on changing conditions such as grade, trailer load, battery state-of-charge, thermal limits, traction conditions, or obstacle proximity. In one example, the processing device increases torque allocation to a trailer with a higher available battery state-of-charge and reduces torque allocation to a trailer with elevated motor temperature, thereby dynamically determining driving characteristics such as torque ceilings, ramp rates, and regenerative braking levels. In some embodiments, each trailer propulsion assembly then independently drives its wheels using the dynamically determined driving characteristics and electrical energy from its respective energy storage device, thereby providing adaptive convoy propulsion without requiring a single mechanical drivetrain shared across all trailers. Further, in some embodiments, the dynamic determination includes speed synchronization controls so that multiple trailers in a train configuration maintain a coordinated speed and acceleration profile. Further, in some embodiments, the processing device independently commands each trailer propulsion assembly to support turning and braking events by modulating torque per trailer, thereby improving stability during cornering and reducing longitudinal oscillations in the coupled series.

In some embodiments, the apparatus includes one or more additional sensors communicatively coupled with the processing device, where the additional sensors monitor one or more additional parameters associated with at least one of the apparatus and the environment. As used herein, “additional parameters” include solar irradiance, wind speed, ambient temperature, battery pack temperature, battery internal resistance estimate, motor temperature, inverter temperature, coupling load, cargo load estimate, and/or facility power availability. In some embodiments, the processing device generates additional sensor data based on the monitored additional parameters, where “additional sensor data” includes processed values such as predicted harvested energy, thermal headroom, and available export power. In one example, the processing device analyzes irradiance and wind measurements to estimate near-term energy harvesting capability and determines movement characteristics such as an energy-limited torque cap or an allowable duty cycle for propulsion; the processing device then generates propulsion and braking commands based on those movement characteristics. Further, in some embodiments, the additional sensors include temperature sensors positioned within or adjacent to the energy storage device to detect abnormal thermal conditions, and the processing device initiates a safety response that includes reducing propulsion output, disabling charging, and/or isolating the energy storage device using contactors. Further, in some embodiments, the safety response includes disengaging a trailer from a coupled convoy or navigating the trailer to a predefined isolation location to reduce risk to nearby equipment or facilities. Further, in some embodiments, the processing device uses the additional sensor data to select whether harvested energy is used for propulsion, storage charging, or auxiliary systems (e.g., refrigeration, lighting, or cabin electronics), thereby improving overall energy utilization.

In some embodiments, the apparatus includes one or more electrical coupling elements coupled to the trailer body and electrically coupled with the energy storage devices, where the electrical coupling elements connect to electrical interfaces of one or more electrical systems. As used herein, “electrical coupling elements” include conductive connectors (plugs, receptacles), cables, contactors/relays, fuses, and/or power electronics interfaces such as a bidirectional inverter/charger, rectifier, transformer, or direct-current-to-direct-current (DC-to-DC) converter. As used herein, “electrical systems” include a warehouse electrical distribution system, a building energy management system, a utility-grid interconnect, a microgrid, and/or an electric vehicle charging subsystem. Further, one or more energy transfer controllers are operatively coupled with the energy storage devices to enable transfer of electrical energy between the energy storage devices and the electrical systems according to one or more constraints based on the connection. To reduce structural ambiguity, an “energy transfer controller” includes, in example implementations, a bidirectional inverter/charger, metering circuitry (voltage and current sensors), controllable contactors, and a controller executing transfer logic. As used herein, “constraints” include measurable limits such as minimum battery state-of-charge reserve, maximum export current, maximum import current, permitted export window (time-of-use), facility load threshold, grid voltage/frequency compliance bounds, and thermal safety thresholds. In some embodiments, the processing device determines the constraints and generates one or more transfer control commands (e.g., inverter power setpoint, contactor open/close states, ramp-rate limits), and the energy transfer controller enables energy transfer consistent with the constraints and transfer control commands, such as exporting surplus trailer energy while stationary at a dock or importing energy to charge the trailer storage device. Further, in some embodiments, when the trailer is parked at a loading dock or rest area, the electrical coupling elements connect the trailer energy storage device to a facility electrical system so that the trailer operates as a power source for warehouse loads during peak demand intervals. Further, in some embodiments, the bidirectional inverter/charger is controlled to export surplus energy generated by solar and wind harvesting and to import energy during off-peak intervals, while enforcing the constraints to preserve sufficient energy for trailer readiness and safe maneuvering. Further, in some embodiments, the electrical coupling elements include an interface for wired charging in addition to wireless charging, thereby providing redundant charging options based on site infrastructure.

In some embodiments, the processing device determines an amount of electrical energy transferred from the energy storage devices to the electrical systems and generates one or more energy credits based on that amount, and transfers the energy credits to one or more accounts. As used herein, “amount of electrical energy transferred” is measured and/or computed using metering circuitry (e.g., voltage and current sensors sampled over time) to produce a value in kilowatt-hours (kWh) with timestamps. As used herein, “energy credits” include electronic records representing value associated with exported energy (e.g., net metering credits, facility credits, fleet accounting credits), stored in a database or ledger. As used herein, “accounts” include utility billing accounts, fleet owner accounts, operator accounts, or internal enterprise ledgers associated with an entity identifier for a trailer or trailer owner. In one example, the processing device logs 12.4 kWh exported during a docked interval, converts that exported amount into a credit record according to a selected tariff or credit schedule, and updates a corresponding account record to reflect the credited value. Further, in some embodiments, energy credits are generated in response to measured export to an external grid or facility and are tracked per trailer identifier so that individual trailer owners or fleet operators receive credit allocation based on actual delivered energy. Further, in some embodiments, the processing device provides a user interface application that reports energy generation, consumption, and export quantities and stores the data used to compute energy credits, thereby supporting auditability and reducing ambiguity in energy credit determination.

In some embodiments, the energy harvesting devices include one or more solar energy harvesting devices comprising one or more coatings of solar paint applied to exterior surfaces of the trailer body and one or more transparent film cells disposed on the exterior surfaces over the solar paint coatings. As used herein, “solar paint” refers to a coating containing photovoltaic materials or photovoltaic microstructures that generate electrical energy in response to incident light; and “transparent film cells” refer to thin-film photovoltaic layers (flexible or semi-transparent laminates) that transmit at least a portion of visible light while converting another portion into electrical energy, thereby increasing total harvested energy under direct and diffuse light conditions. In one example implementation, solar paint is applied to the trailer sidewalls and roof panels and electrically routed to a maximum power point tracking (MPPT) charge controller, while transparent thin-film cells are laminated over high-exposure regions and connected in series/parallel strings to raise output voltage/current for charging the energy storage device. Further, in some embodiments, the solar paint includes photovoltaic cells embedded within the coating layer so that large exterior surfaces of the trailer are utilized for energy harvesting without substantially increasing trailer profile height. Further, in some embodiments, the transparent film cells are selected to improve performance under diffuse lighting conditions and to continue energy harvesting during partially shaded or cloudy conditions.

In some embodiments, the energy harvesting devices include one or more wind energy harvesting devices comprising one or more wind turbines mounted on one or more locations of the trailer body. As used herein, “wind turbine” includes a horizontal-axis turbine, vertical-axis turbine, ducted turbine, or microturbine, coupled to an electrical generator and power-conditioning electronics (e.g., rectifier and DC-to-DC converter). In one example, compact turbines are mounted along a forward roof edge or side edges where airflow increases during transit, and generated electrical energy is conditioned and supplied to the energy storage device to reduce dependence on external charging. Further, in some embodiments, the wind turbines are positioned at airflow-optimized regions, including trailer edges and a front roof region, so that power generation occurs during motion and can be particularly beneficial during nighttime transit when solar availability is reduced. Further, in some embodiments, the wind turbines include high-efficiency generator assemblies sized to provide auxiliary charging current to the energy storage device while maintaining acceptable aerodynamic drag.

In some embodiments, the energy harvesting devices include one or more inductive power harvesting devices comprising one or more inductive power transfer interfaces mounted to one or more locations on the trailer body, where the inductive power harvesting devices harvest electrical energy from electromagnetic energy. As used herein, an “inductive power transfer interface” includes a receiver coil assembly, magnetic flux guidance or shielding (e.g., ferrite and/or conductive shielding), resonant capacitors (for resonant coupling embodiments), a rectifier, and a charge controller that outputs regulated DC power to the energy storage device. In one example implementation, the inductive power transfer interface is mounted beneath the trailer and aligned with a stationary charging surface embedded in pavement at a dock or rest area, such that an alternating magnetic field from the stationary surface induces current in the receiver coil to charge the trailer energy storage device without a conductive plug. Further, in some embodiments, the stationary charging surface is implemented as an underlayment charging pad installed at docks, parking areas, or rest stops to enable hands-free charging without manual connection. Further, in some embodiments, the inductive power transfer interface supports cumulative energy transfer coordination in which multiple parked units provide energy to a shared building control unit or receive charge under site-level scheduling control, thereby improving charging efficiency and facility integration.

In some embodiments, the apparatus is implemented on a trailer body (e.g., a frame, chassis, container body, or combination thereof) that supports one or more axles, suspension components, and wheels, and that couples to a tractor via a hitch/kingpin or other towing interface. The trailer body can include one or more mounting regions, brackets, rails, or internal cavities for packaging electrical and electromechanical components, including energy harvesting devices, energy storage devices, controllers, wiring harnesses, and power electronics. Electrical distribution within the trailer may be provided by a DC bus, power distribution module, or segmented power rails that supply propulsion assemblies, steering assemblies, sensors, and auxiliary loads.

In some embodiments, an energy harvesting device includes a harvesting transducer or generator mechanically and/or electrically coupled to the trailer body and arranged to extract energy from the environment surrounding the trailer. The harvested energy can be provided as electrical power directly (e.g., from a photovoltaic film, wind generator, inductive receiver, or thermoelectric element) or converted to electrical power via a generator coupled to a mechanical input (e.g., turbine rotation, vibration-induced motion, or other relative movement). The energy harvesting device may be implemented as one module or a set of distributed modules positioned at different locations on the trailer body (e.g., roof, sidewalls, undercarriage, fairings, or wheel-well regions) to increase total harvested power and/or to reduce shading and airflow losses.

In some embodiments, the energy harvesting device further includes power conditioning circuitry such as rectifiers, DC-DC converters, maximum power point tracking (MPPT) circuitry, voltage regulation stages, and protective components (e.g., fuses, transient suppression, isolation devices). The power conditioning circuitry can output regulated power to a common DC link for storage and/or direct consumption by propulsion assemblies. Mechanical mounting features may include vibration-isolating mounts, aerodynamic housings, sealing gaskets, and serviceable fasteners to support on-road environments, weather exposure, and maintenance access.

In some embodiments, a trailer propulsion assembly includes one or more electric traction machines mechanically coupled to one or more wheels to provide propulsive torque. The traction machine can be implemented as a hub motor, an axle-mounted motor coupled through a gearbox, a motor coupled via a belt/chain drive, or a motor integrated with a differential. The propulsion assembly may further include an inverter or motor drive electronics, torque sensors, wheel-speed sensors, and braking components enabling regenerative braking and/or coordinated friction braking.

In some embodiments, the propulsion assembly is configured to drive a wheel according to “driving characteristics” that include one or more of commanded torque, wheel speed, direction of rotation, acceleration profile, traction or slip targets, torque limits, regenerative braking level, and coordination settings among multiple wheels or axles. For example, the propulsion assembly can implement closed-loop wheel speed control and/or torque control using sensor feedback, and can apply torque vectoring across multiple wheels to improve stability, turning, and low-traction performance. The propulsion assembly may be configured to operate in assist modes (adding propulsive force during towing), maneuver modes (low-speed positioning in a yard), and braking/energy recovery modes.

In some embodiments, the processing device is implemented as an electronic control unit (ECU) mounted on or within the trailer body and comprising one or more processors, memory, and communication interfaces. The processing device can execute control logic to determine commands for propulsion and steering based on movement data, sensor data, and operational constraints. The processing device may generate low-level actuator commands (e.g., torque or current commands to motor drives, steering angle commands to steering actuators) and/or higher-level setpoints (e.g., target speed, target yaw rate, target articulation angle, or trajectory waypoints) that are translated by subsystem controllers.

In some embodiments, the processing device includes safety features such as watchdog monitoring, redundant sensing inputs, fault handling states, and conservative fallback behaviors (e.g., disabling propulsion, applying braking, or limiting torque) when faults are detected. The processing device can coordinate energy usage among harvesting, storage, propulsion, and export functions by selecting power modes, limiting peak currents, prioritizing critical loads, and maintaining reserve SoC thresholds.

In some embodiments, the trailer includes non-steerable wheels mounted at a rear portion of the trailer body and steerable wheels mounted at a front portion of the trailer body, where “front” and “rear” refer to the direction of travel during towing. A steering assembly can include a steering linkage and an actuator configured to adjust a steering angle of the steerable wheels. Example actuators include electric rotary actuators coupled to a steering rack, linear actuators coupled to a tie-rod assembly, or electrohydraulic actuators controlling a hydraulic steering mechanism.

In some embodiments, the steering assembly further includes steering angle sensors, actuator position sensors, and/or force/torque sensors enabling closed-loop steering control. The processing device can command steering angles (or steering rates) based on a desired trailer trajectory, articulation dynamics, or maneuvering objectives. In yard maneuvering or autonomous positioning, the steering assembly can cooperate with the propulsion assembly to execute low-speed turns, alignment to a dock, lane centering within a yard corridor, or reduced turning radius maneuvers.

In some embodiments, the tractor includes one or more physical interfaces that can be actuated by an operator and/or an automated mechanism, such as pedals (accelerator, brake), steering wheel or steering actuator, gear selector, turn controls, and auxiliary switches. Tractor sensors may detect actions performed on these interfaces, such as pedal position sensors, steering angle sensors, torque sensors, switch state sensors, and/or actuator feedback sensors. Tractor controllers can generate movement data based on the detected actions, for example, by encoding operator intent (desired acceleration, braking demand, steering command) and/or by reporting interpreted vehicle control states.

In some embodiments, the tractor includes a robotic assembly configured to physically actuate one or more tractor interfaces. The robotic assembly can include one or more actuators, linkages, end-effectors, and mounting structures arranged to apply force or displacement to pedals, steering mechanisms, or switches, optionally with tactile/force feedback and position sensing. The robotic assembly may receive control commands from an external device (e.g., remote operator station, autonomous driving controller, yard management system), and the tractor controllers can generate movement data that reflects the commanded robotic actions and resulting vehicle response, enabling coordinated trailer control during remote or automated operations.

In some embodiments, a tractor control assembly transitions between operational states, such as a first state in which a propulsion interface actuates tractor propulsion (e.g., manual or operator-driven propulsion) and a second state in which propulsion actuation is limited, automated, or constrained. Steering actuation can be enabled in both states, for example, to allow steering authority for safety maneuvers even when propulsion authority changes. Tractor controllers may generate first movement data in the first state and second movement data in the second state, and the trailer processing device can adjust trailer propulsion/steering behavior based on which movement data set is active and the corresponding state-dependent constraints.

In some embodiments, the system includes two or more trailers mechanically coupled in series, where each trailer includes a respective trailer body, energy harvesting device, energy storage device, and trailer propulsion assembly. Each trailer can be controlled independently based on commands generated by a common processing device or by distributed processing devices that coordinate via a communication link. Independent control can include issuing different torque commands to different trailers to manage push/pull forces along the train, reduce coupling loads, and improve tracking through turns or uneven terrain.

In some embodiments, the processing device dynamically determines driving characteristics for the wheels of each trailer based on real-time operating conditions. For example, the processing device can allocate torque among trailers based on available stored energy, traction estimates, trailer load, articulation angles, and desired train dynamics, and can adjust regenerative braking distribution to maintain stability and to keep each storage device within SoC and temperature constraints.

In some embodiments, the apparatus includes additional sensors configured to monitor parameters associated with the apparatus and/or its environment, such as ambient temperature, wind speed and direction, solar irradiance, precipitation, road surface condition, visibility, proximity to obstacles, or traffic context. The processing device can generate additional sensor data by sampling and processing these signals, and can analyze the additional sensor data to determine movement characteristics (e.g., reduced traction limits under rain, higher assist torque under headwinds, speed limits within geofenced areas, or altered steering aggressiveness near obstacles). Commands for propulsion and steering can be generated based on these inferred movement characteristics to improve safety and energy efficiency.

In some embodiments, the apparatus includes electrical coupling elements mounted to the trailer body and electrically coupled to the energy storage device. The electrical coupling elements can include plug-and-socket connectors, conductive contacts, charge ports, busbar interfaces, or inductive coupling pads configured to connect to electrical interfaces of external electrical systems such as a depot microgrid, a charging station, a tractor electrical system, or auxiliary equipment. The coupling can support one-way energy export, one-way charging, or bidirectional energy transfer.

In some embodiments, the apparatus includes one or more energy transfer controllers operatively coupled with the energy storage device and configured to manage energy transfer according to constraints. The energy transfer controller may include bidirectional DC-DC converters, inverters (for AC export), metering circuitry, isolation and grounding elements, and protection devices. Constraints can include electrical limits (maximum current, voltage windows, ramp rates), storage limits (SoC reserve, temperature limits, SoH considerations), contractual or pricing limits (time-of-use cost, demand response commitments), location-based limits (geofenced export enablement), and safety limits (connector latch status, insulation fault detection). The processing device can determine applicable constraints and generate transfer control commands that cause the energy transfer controller to enable, disable, or modulate energy flow while satisfying the constraints.

In some embodiments, the present disclosure describes an apparatus for facilitating movement of one or more trailers. Further, the disclosed apparatus may include a trailer body configured to support cargo and axle assemblies. Further, the disclosed apparatus may include one or more electric propulsion assemblies mechanically coupled to one or more trailer wheels. Further, the disclosed apparatus may include an energy storage assembly mounted to the trailer body. Further, the disclosed apparatus may include a trailer-resident electronic control unit (ECU) operatively coupled to the propulsion assemblies and the energy storage assembly. Further, the disclosed apparatus may include a communication interface configured to exchange control data with a tractor unit or a remote operator.

Further, the one or more electric propulsion assemblies may be implemented as hub motors, axle-mounted motors, or electric axle modules, and are configured to generate controlled tractive force along a longitudinal axis of the trailer body.

Further, when mechanically coupled to the tractor unit, the trailer-resident ECU selectively generates propulsion torque that assists or supplements tractor-generated propulsion. In some embodiments, propulsion output is dynamically adjusted based on one or more of tractor torque demand, vehicle speed, articulation angle, trailer load, and available stored energy. Further, the given cooperative propulsion configuration reduces mechanical strain on the tractor drivetrain and improves fuel efficiency.

In some embodiments, the disclosed apparatus further includes one or more energy harvesting devices mounted to the trailer body and electrically coupled to the energy storage assembly. Further, the energy harvesting devices may be configured to supplement stored energy by harvesting energy from the surrounding environment and are not required to serve as a primary propulsion source.

Further, the energy storage assembly may include one or more battery packs mounted beneath the trailer body to lower a center of gravity and improve vehicle stability. Further, the trailer-resident ECU may be configured to monitor a state-of-charge of the energy storage assembly and to inhibit propulsion when energy levels fall below predefined thresholds.

In some embodiments, the one or more trailers may include wired and/or wireless charging interfaces. Further, an inductive charging receiver may be mounted beneath the trailer body and configured to receive electrical power from a stationary charging surface when the trailer is positioned above the surface.

In some embodiments, the disclosed apparatus includes steerable trailer wheels and one or more steering assemblies configured to steer the wheels based on control commands generated by the trailer-resident ECU, thereby enhancing maneuverability during low-speed operation.

In some embodiments, the one or more trailers is operable in a fully autonomous mode without a tractor unit. In the given mode, the trailer-resident ECU generates propulsion, braking, and steering commands based on sensor data indicative of vehicle motion and the surrounding environment. Control commands may be generated autonomously or received from a remote operator station.

In some embodiments, a robotic actuation assembly may be provided to mechanically actuate physical control interfaces of a tractor unit. Such robotic actuation converts electronic control signals into mechanical movements corresponding to human control inputs and is not required for trailer-resident propulsion or autonomous trailer operation.

In some embodiments, the present disclosure describes a self-propelled semi-trailer system (i.e., apparatus). Further, the self-propelled semi-trailer system may include a trailer body configured to support cargo. Further, the self-propelled semi-trailer system may include one or more wheels mounted to the trailer body. Further, the self-propelled semi-trailer system may include one or more electric propulsion assemblies operatively coupled to one or more of the wheels and configured to generate tractive force. Further, the self-propelled semi-trailer system may include an onboard energy storage assembly mounted to the trailer body and electrically coupled to the one or more electric propulsion assemblies. Further, the self-propelled semi-trailer system may include a trailer-resident electronic control unit (ECU) operatively coupled to the electric propulsion assembly and the onboard energy storage assembly. Further, the trailer-resident ECU may be configured to selectively operate the self-propelled semi-trailer in a self-propelled mode in which the electric propulsion assembly propels the trailer independently of a tractor engine. Further, the trailer-resident ECU may be further configured to selectively operate the self-propelled semi-trailer in a tractor-assisted mode in which the one or more electric propulsion assemblies generate forward tractive force while the self-propelled semi-trailer is mechanically coupled to a tractor unit, thereby reducing propulsion torque demand on the tractor unit.

In some embodiments, the present disclosure describes a method of operating a semi-trailer. Further, the disclosed method may include providing a semi-trailer having an electric propulsion assembly, an onboard energy storage assembly, and a trailer-resident electronic control unit (ECU). Further, the disclosed method may include determining, at the trailer-resident ECU, an operating mode of the semi-trailer. Further, in response to determining a self-propelled operating mode, the disclosed method may include generating propulsion control signals that cause the electric propulsion assembly to propel the semi-trailer independently of a tractor engine. Further, in response to determining a tractor-assisted operating mode while the semi-trailer is mechanically coupled to a tractor unit, the disclosed method may include generating propulsion control signals that cause the electric propulsion assembly to provide forward tractive force that assists propulsion of the tractor unit. Further, the operating mode is selected based on at least one of energy availability, vehicle speed, trailer load, or received control signals.

In some embodiments, the present disclosure may describe a method of retrofitting an existing semi-trailer to enable powered operation. Further, the disclosed method may include mounting one or more electric propulsion assemblies to one or more wheels of the semi-trailer. Further, the disclosed method may include mounting an energy storage assembly to a chassis portion of the semi-trailer. Further, the disclosed method may include installing a trailer-resident electronic control unit (ECU) on the semi-trailer. Further, the disclosed method may include electrically coupling the electric propulsion assembly and the energy storage assembly to the trailer-resident ECU. Further, the trailer-resident ECU is configured to selectively operate the semi-trailer in (i) a self-propelled mode independent of a tractor engine and (ii) a tractor-assisted mode in which the semi-trailer provides forward tractive force while mechanically coupled to a tractor unit.

Further, in some embodiments, the self-propelled semi-trailer system may include a one or more sensors configured to provide vehicle motion, load, or environmental data to the trailer-resident ECU.

Further, in some embodiments, the trailer-resident ECU generates propulsion torque commands based on sensor data indicative of at least one of vehicle speed, trailer load, articulation angle, or traction conditions.

Further, in some embodiments, the self-propelled semi-trailer system may include one or more energy harvesting devices mounted to the trailer body and electrically coupled to the onboard energy storage assembly.

Further, in some embodiments, the one or more energy harvesting devices may include one or more of a photovoltaic structure, a wind-driven generator, or an inductive power transfer interface.

Further, in some embodiments, the trailer-resident ECU regulates energy flow between the energy harvesting device and the energy storage assembly.

Further, in some embodiments, the self-propelled semi-trailer system may include a communication interface configured to exchange control data between the trailer-resident ECU and a tractor control system.

Further, in some embodiments, the trailer-resident ECU transmits coordinated motion control signals to the tractor unit while mechanically coupled to the semi-trailer.

Further, in some embodiments, the self-propelled semi-trailer system may include a robotic actuation assembly configured to mechanically actuate at least one physical control interface of the tractor unit.

Further, in some embodiments, the robotic actuation assembly converts electronic control signals into mechanical movements corresponding to human control inputs.

Further, in some embodiments, the trailer comprises steerable wheels and at least one steering actuator configured to steer the steerable wheels based on commands generated by the trailer-resident ECU.

Further, in some embodiments, the semi-trailer is one of two or more semi-trailers mechanically coupled in series, and wherein each semi-trailer includes a respective propulsion assembly and energy storage assembly.

Further, in some embodiments, the trailer-resident ECU independently controls propulsion output of each semi-trailer based on operating conditions of the respective semi-trailer.

In some embodiments, the present disclosure describes a self-propelled semi-trailer system includes an electric propulsion assembly coupled to one or more trailer wheels, an onboard energy storage assembly, and a trailer-resident electronic control unit (ECU). Further, the ECU selectively operates the semi-trailer in a self-propelled mode in which the trailer generates tractive force independently of a tractor engine, and a tractor-assisted mode in which the trailer provides forward propulsion while mechanically coupled to a tractor unit to reduce tractor torque demand. Further, the self-propelled semi-trailer system is configurable for retrofit installation on existing semi-trailers and supports coordinated operation with a coupled tractor unit. Further, energy harvesting devices and robotic actuation interfaces may be optionally integrated as supplemental features.

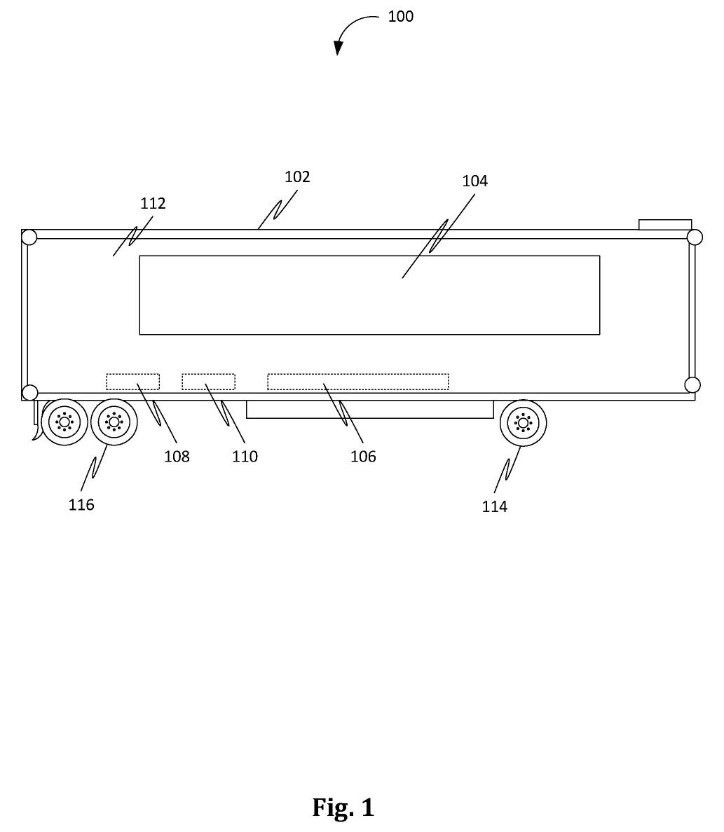

FIG. 1 is a side view of an apparatus 100 for facilitating a movement of one or more trailers 102, in accordance with some embodiments. Accordingly, the apparatus 100 may include one or more energy harvesting devices 104, one or more energy storage devices 106, one or more trailer propulsion assemblies 108, and a processing device 110.

Further, the one or more energy harvesting devices 104 may be coupled to one or more trailer bodies 112 of the one or more trailers 102. Further, the one or more energy harvesting devices 104 may be configured for generating electrical energy by harvesting energy from an environment of the apparatus 100. Further, the one or more trailers 102 may include a vehicle.

Further, the one or more energy storage devices 106 may be coupled to the one or more trailer bodies 112. Further, the one or more energy storage devices 106 may be electrically coupled with the one or more energy harvesting devices 104. Further, the one or more energy storage devices 106 may be configured for storing the electrical energy.

Further, the one or more trailer propulsion assemblies 108 may be coupled to the one or more trailer bodies 112. Further, the one or more trailer propulsion assemblies 108 may be operatively coupled with one or more wheels 114-116 mounted on the one or more trailer bodies 112. Further, the one or more trailer propulsion assemblies 108 may be configured for driving the one or more wheels 114-116 with one or more driving characteristics using the electrical energy for propelling the one or more trailers 102. Further, the one or more trailers 102 may be maneuverable.

Further, the processing device 110 may be operatively coupled with the one or more trailer propulsion assemblies 108, the one or more energy storage devices 106, and the one or more energy harvesting devices 104. Further, the processing device 110 may be configured for generating one or more commands for controlling at least one movement of the one or more trailers 102. Further, the driving of the one or more wheels 114-116 with the one or more driving characteristics using the electrical energy may be based on the one or more commands. Further, the controlling of the at least one movement may include controlling propulsion and steering of the one or more trailers 102.

Further, in some embodiments, the one or more wheels 114-116 may be mounted to a rear portion of the one or more trailer bodies 112. Further, the one or more trailers 102 may include one or more steerable wheels 202 mounted to a front portion of the one or more trailer bodies 112. Further, the apparatus 100 may include one or more steering assemblies 204 coupled to the one or more trailer bodies 112. Further, the one or more steering assemblies 204 may be configured for steering the one or more steerable wheels 202 based on the one or more commands. Further, the one or more trailers 102 may be maneuvered based on the steering of the one or more steerable wheels 202.

Further, in an embodiment, the processing device 110 may be configured for analyzing one or more movement data. Further, the processing device 110 may be configured for determining one or more movement characteristics for the at least one movement associated with the one or more trailers 102 based on the analyzing of the one or more movement data. Further, the generating of the one or more commands may be further based on the one or more movement characteristics.

In an embodiment, the apparatus 100 may include one or more sensors 302-304 coupled to the one or more trailer bodies 112. Further, the one or more sensors 302-304 may be communicatively coupled with the processing device 110. Further, the one or more sensors 302-304 may be configured for detecting one or more parameters associated with the at least one movement of the one or more trailers 102. Further, the processing device 110 may be configured for generating the one or more movement data associated with the at least one movement of the one or more trailers 102 based on the detecting of the one or more parameters. Further, the analyzing of the one or more movement data may be further based on the generating of the one or more movement data.

Further, in an embodiment, the one or more trailers 102 may be coupled with a tractor 402. Further, the tractor 402 may include one or more tractor controllers 404. Further, the apparatus 100 may include a communication device 406 communicatively coupled with the processing device 110. Further, the communication device 406 may be configured for receiving the one or more movement data from the one or more tractor controllers 404. Further, the one or more movement data may be further associated with one or more movement operations associated with the tractor 402.

Further, in an embodiment, the tractor 402 may include one or more tractor sensors 502 communicatively coupled with the one or more tractor controllers 404. Further, the one or more tractor sensors 502 may be configured for detecting one or more actions performed on one or more physical interfaces 602 of the tractor 402. Further, the one or more actions correspond to the one or more movement operations associated with the tractor 402. Further, the one or more tractor controllers 404 may be configured for generating the one or more movement data based on the detecting of the one or more actions.

Further, in an embodiment, the tractor 402 may include at least one robotic assembly 604 and the one or more physical interfaces 602. Further, the at least one robotic assembly 604 may be configured for performing one or more actions on the one or more physical interfaces 602. Further, the one or more tractor controllers 404 may be configured for generating the one or more movement data based on the performing of the one or more actions.

Further, in an embodiment, the at least one robotic assembly 604 may be configured for receiving one or more control commands from one or more external devices. Further, the performing of the one or more actions on the one or more physical interfaces 602 by the at least one robotic assembly 604 may be based on the one or more control commands.

Further, in an embodiment, the tractor 402 may include at least one tractor propulsion assembly 702, at least one tractor steering assembly 704, and a control assembly 706. Further, the at least one tractor propulsion assembly 702 may be operatively coupled with at least one propulsion interface 710 of the tractor 402. Further, the at least one tractor steering assembly 704 may be operatively coupled with at least one steering interface 708 of the tractor 402. Further, the control assembly 706 may be configured for transitioning between a first state and a second state. Further, the at least one propulsion interface 710 may be configured for actuating the at least one tractor propulsion assembly 702 in the first state. Further, the at least one steering interface 708 may be configured for actuating the at least one tractor steering assembly 704 in each of the first state and the second state. Further, the one or more tractor controllers 404 may be configured for generating one or more first movement data in the first state. Further, the one or more tractor controllers 404 may be configured for generating one or more second movement data in the second state. Further, the one or more movement data may include the one or more first movement data during the first state. Further, the one or more movement data may include the one or more second movement data during the second state.

In some embodiments, the apparatus 100 may include a communication device 802 communicatively coupled with the processing device 110. Further, the communication device 802 may be configured for receiving one or more movement data from one or more external devices. Further, the processing device 110 may be configured for analyzing the one or more movement data. Further, the processing device 110 may be configured for determining one or more movement characteristics for the at least one movement of the one or more trailers 102 based on the analyzing. Further, the generating of the one or more commands may be further based on the one or more movement characteristics.

Further, in some embodiments, the one or more trailers 102 may include two or more trailers (102 and 902). Further, the one or more trailer bodies 112 may include two or more trailer bodies (112 and 912) of the two or more trailers (102 and 902). Further, the two or more trailer bodies (112 and 912) may be mechanically coupled in series. Further, the one or more energy harvesting devices 104 may include two or more energy harvesting devices (104 and 904). Further, each of the two or more energy harvesting devices (104 and 904) may be coupled with a respective trailer body of the two or more trailer bodies (112 and 912). Further, the one or more energy storage devices 106 may include two or more energy storage devices (106 and 906). Further, each of the two or more energy storage devices (106 and 906) may be coupled with a respective trailer body of the two or more trailer bodies (112 and 912). Further, each of the two or more energy storage devices (106 and 906) may be electrically coupled with a respective energy harvesting device of the two or more energy harvesting devices (104 and 904). Further, the one or more trailer propulsion assemblies 108 may include two or more trailer propulsion assemblies (108 and 908). Further, each of the two or more trailer propulsion assemblies (108 and 908) may be coupled to a respective trailer body of the two or more trailer bodies (112 and 912). Further, each of the two or more trailer propulsion assemblies (108 and 908) may be operatively coupled to the one or more wheels (114-116 and 914-916) of the respective trailer body of the two or more trailer bodies (112 and 912). Further, the controlling of the at least one movement of the one or more trailers 102 may include controlling the at least one movement of each of the two or more trailers (102 and 902). Further, the driving of the one or more wheels 114-116 with the one or more driving characteristics using the electrical energy may include independently driving, by each of the two or more trailer propulsion assemblies (108 and 908), the one or more wheels (114-116 and 914-916) of the respective trailer body of the two or more trailer bodies (112 and 912) with the one or more driving characteristics using the electrical energy from the respective energy storage device based on the one or more commands.

Further, in some embodiments, the processing device 110 may be further configured for dynamically determining the one or more driving characteristics for the one or more wheels (114-116 and 914-916) of each of the two or more trailer bodies (112 and 912). Further, the independently driving, by each of the two or more trailer propulsion assemblies (108 and 908), of the one or more wheels (114-116 and 914-916) of the respective trailer body of the two or more trailer bodies (112 and 912) with the one or more driving characteristics of the one or more wheels (114-116 and 914-916) of the respective trailer body using the electrical energy from the respective energy storage device may be further based on the dynamically determining of the one or more driving characteristics for the one or more wheels (114-116 and 914-916) of each of the two or more trailer bodies (112 and 912).

In further embodiments, the apparatus 100 may include one or more additional sensors 1002 communicatively coupled with the processing device 110. Further, the one or more additional sensors 1002 may be configured for monitoring one or more additional parameters associated with at least one of the apparatus 100 and the environment. Further, the processing device 110 may be configured for generating one or more additional sensor data based on the monitoring of the one or more additional parameters. Further, the processing device 110 may be configured for analyzing the one or more additional sensor data. Further, the processing device 110 may be configured for determining one or more movement characteristics for the at least one movement associated with the one or more trailers 102 based on the analyzing of the one or more additional sensor data. Further, the generating of the one or more commands may be further based on the one or more movement characteristics.

In further embodiments, the apparatus 100 may include one or more electrical coupling elements 1102 and one or more energy transfer controllers 1104. Further, the one or more electrical coupling elements 1102 may be coupled to the one or more trailer bodies 112. Further, the one or more electrical coupling elements 1102 may be electrically coupled with the one or more energy storage devices 106. Further, the one or more electrical coupling elements 1102 may be configured for connecting to one or more electrical interfaces 1106 of one or more electrical systems 1108. Further, the one or more energy transfer controllers 1104 may be operatively coupled with the one or more energy storage devices 106. Further, the one or more energy transfer controllers 1104 may be configured for enabling a transfer of the electrical energy between the one or more energy storage devices 106 and the one or more electrical systems 1108 according to one or more constraints based on the connecting. Further, the processing device 110 may be operatively coupled with the one or more energy transfer controllers 1104. Further, the processing device 110 may be configured for determining the one or more constraints for the transfer of the electrical energy between the one or more energy storage devices 106 and the one or more electrical systems 1108. Further, the processing device 110 may be configured for generating one or more transfer control commands based on the determining of the one or more constraints. Further, the enabling of the transfer of the electrical energy between the one or more energy storage devices 106 and the one or more electrical systems 1108 according to the one or more constraints may be further based on the one or more transfer control commands.

Further, in an embodiment, the processing device 110 may be configured for determining an amount of the electrical energy transferred from the one or more energy storage devices 106 to the one or more electrical systems 1108. Further, the processing device 110 may be configured for generating one or more energy credits based on the amount of the electrical energy transferred from the one or more energy storage devices 106 to the one or more electrical systems 1108. Further, the processing device 110 may be configured for transferring the one or more energy credits to one or more accounts.

Further, in some embodiments, the one or more energy harvesting devices 104 may include one or more solar energy harvesting devices 1202. Further, the one or more solar energy harvesting devices 1202 may include one or more coatings 1204 of one or more solar paints applied to one or more exterior surfaces of the one or more trailer bodies 112, and one or more transparent film cells 1206 disposed on the one or more exterior surfaces over the one or more coatings 1204 of the one or more solar paints. Further, the one or more solar energy harvesting devices 1202 may be configured for harvesting the electrical energy from light in the environment.

Further, in some embodiments, the one or more energy harvesting devices 104 may include one or more wind energy harvesting devices 1302. Further, the one or more wind energy harvesting devices 1302 may include one or more wind turbines 1304-1306 mounted on one or more locations of the one or more trailer bodies 112. Further, the one or more wind energy harvesting devices 1302 may be configured for harvesting the electrical energy from the wind in the environment.

Further, in some embodiments, the one or more energy harvesting devices 104 may include one or more inductive power harvesting devices 1402. Further, the one or more inductive power harvesting devices 1402 may include one or more inductive power transfer interfaces. Further, the one or more inductive power transfer interfaces may be mounted to one or more locations on the one or more trailer bodies 112. Further, the one or more inductive power harvesting devices 1402 may be configured for harvesting the electrical energy from electromagnetic energy.

Further, in some embodiments, the apparatus 100 may include a trailer system.

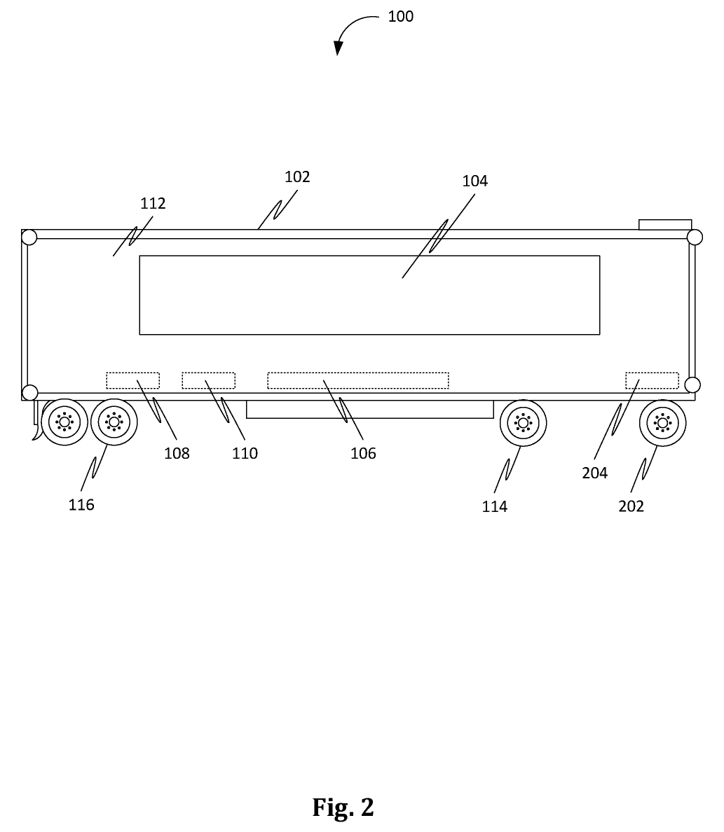

FIG. 2 is a side view of the apparatus 100 for facilitating the movement of the one or more trailers 102, in accordance with some embodiments. Further, the one or more trailers 102 may include the one or more steerable wheels 202.

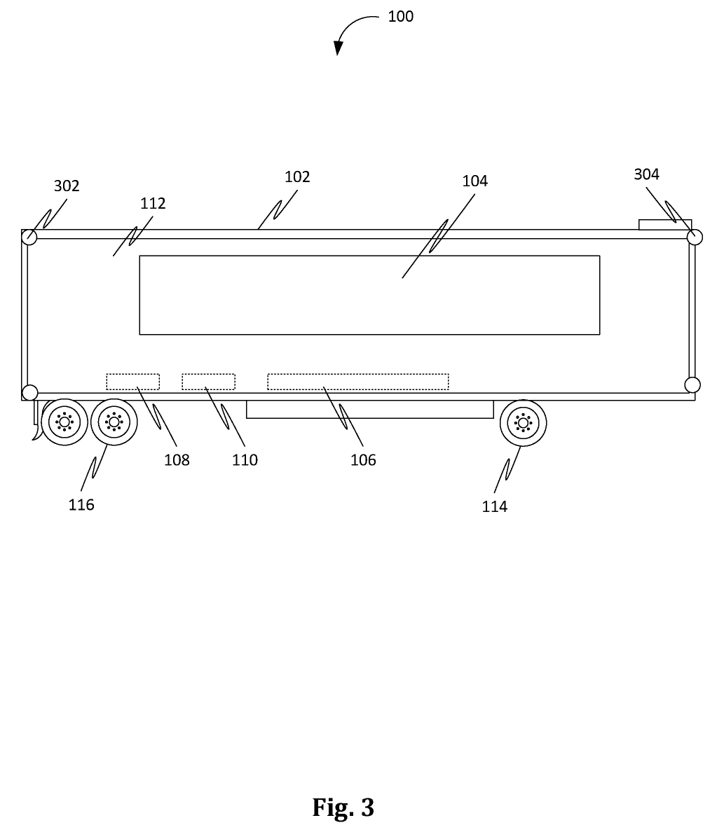

FIG. 3 is a side view of the apparatus 100 for facilitating the movement of the one or more trailers 102, in accordance with some embodiments. Further, the apparatus 100 may include the one or more sensors 302-304 coupled to the one or more trailer bodies 112.

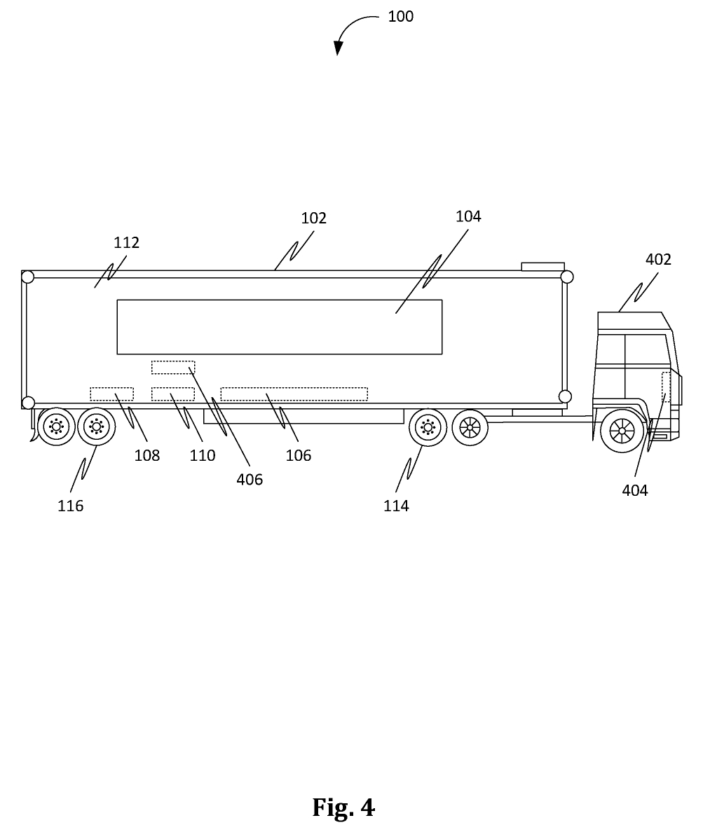

FIG. 4 is a side view of the apparatus 100 for facilitating the movement of the one or more trailers 102 with the tractor 402, in accordance with some embodiments. Further, the one or more trailers 102 may be coupled with the tractor 402.

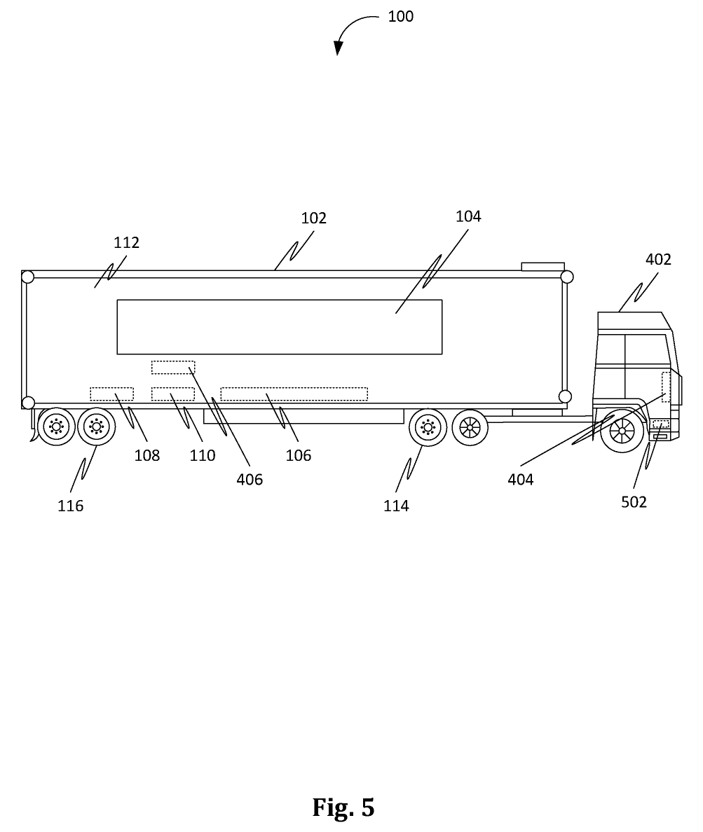

FIG. 5 is a side view of the apparatus 100 for facilitating the movement of the one or more trailers 102 with the tractor 402, in accordance with some embodiments. Further, the tractor 402 may include the one or more tractor sensors 502 communicatively coupled with the one or more tractor controllers 404.

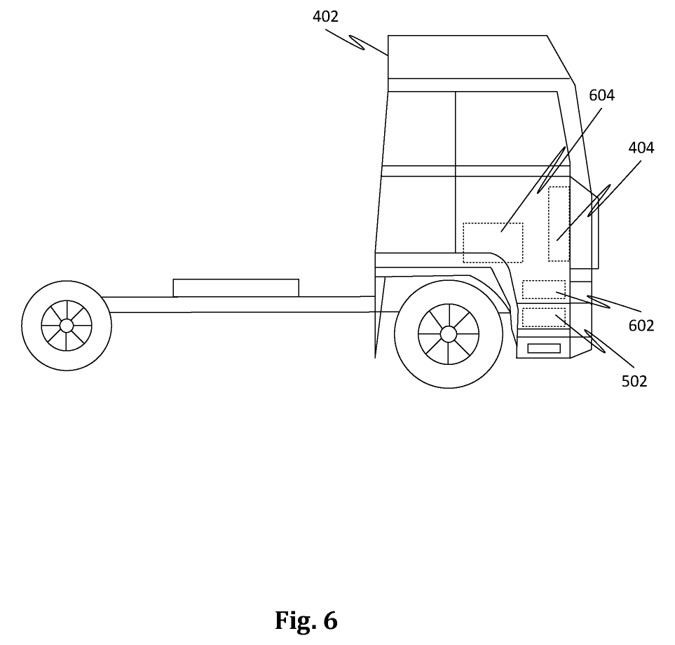

FIG. 6 is a side view of the tractor 402 associated with the apparatus 100, in accordance with some embodiments. Further, the tractor 402 may include the at least one robotic assembly 604 and the one or more physical interfaces 602.

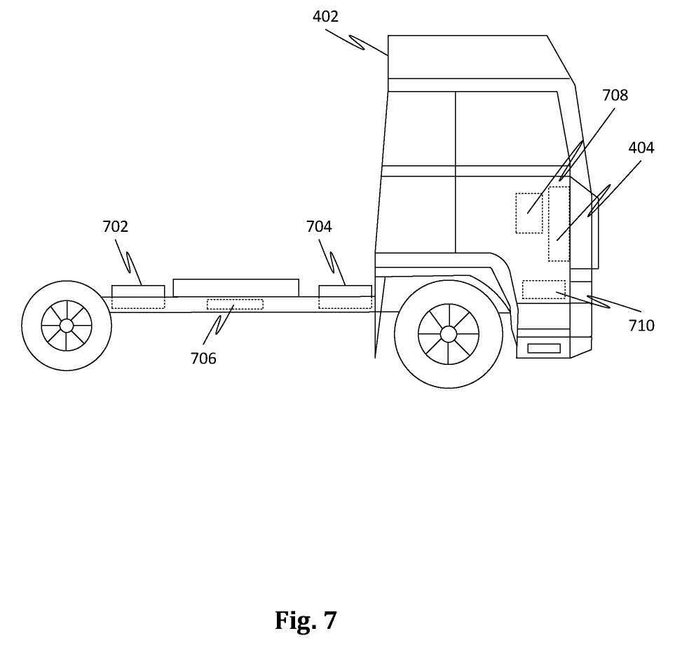

FIG. 7 is a side view of the tractor 402 associated with the apparatus 100, in accordance with some embodiments. Further, the tractor 402 further may include the at least one tractor propulsion assembly 702, the at least one tractor steering assembly 704, and the control assembly 706.

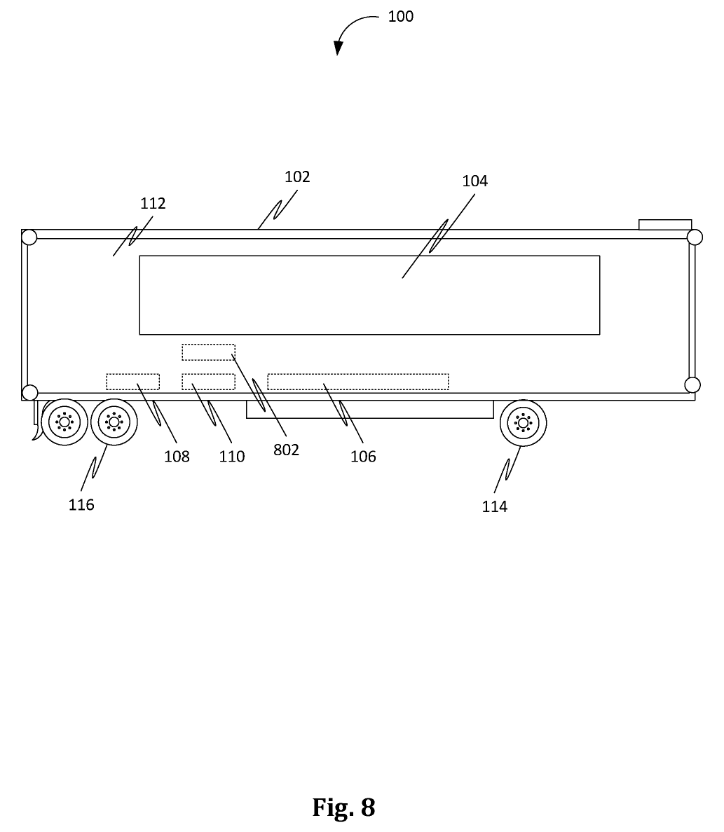

FIG. 8 is a side view of the apparatus 100 for facilitating the movement of the one or more trailers 102, in accordance with some embodiments. Further, the apparatus 100 may include the communication device 802 communicatively coupled with the processing device 110. Further, the communication device 802 may be configured for receiving one or more movement data from one or more external devices.

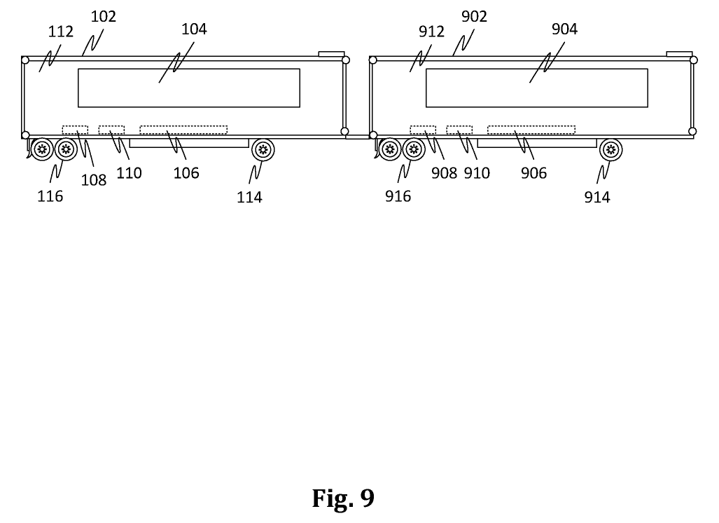

FIG. 9 is a side view of the two or more trailers (102 and 902) of the apparatus 100, in accordance with some embodiments. Further, the one or more trailers 102 may include the two or more trailers (102 and 902). Further, the one or more trailer bodies 112 may include the two or more trailer bodies (112 and 912) of the two or more trailers (102 and 902).

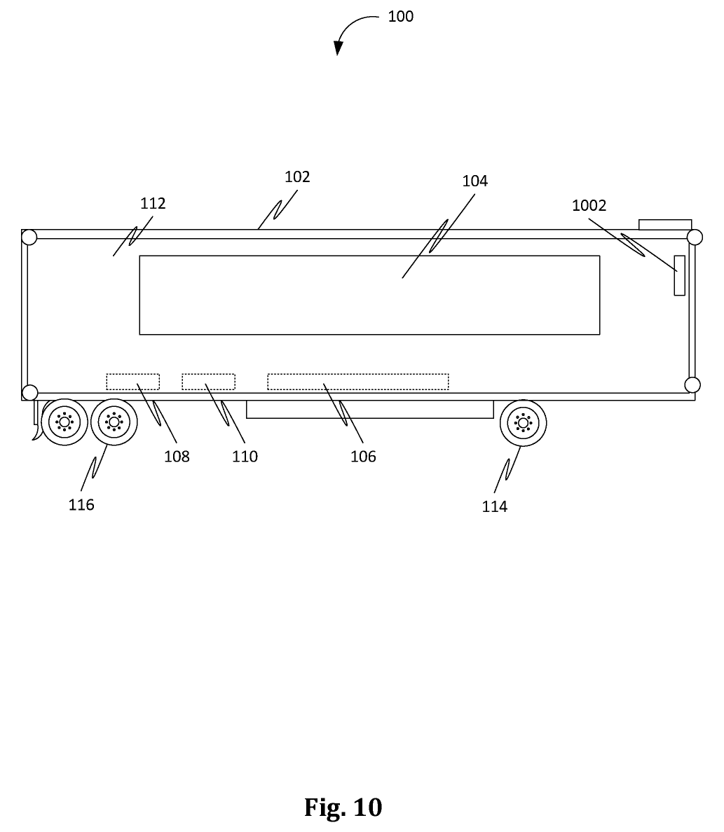

FIG. 10 is a side view of the apparatus 100 for facilitating the movement of the one or more trailers 102, in accordance with some embodiments. Further, the apparatus 100 may include the one or more additional sensors 1002 communicatively coupled with the processing device 110. Further, the one or more additional sensors 1002 may be configured for monitoring one or more additional parameters associated with at least one of the apparatus 100 and the environment.

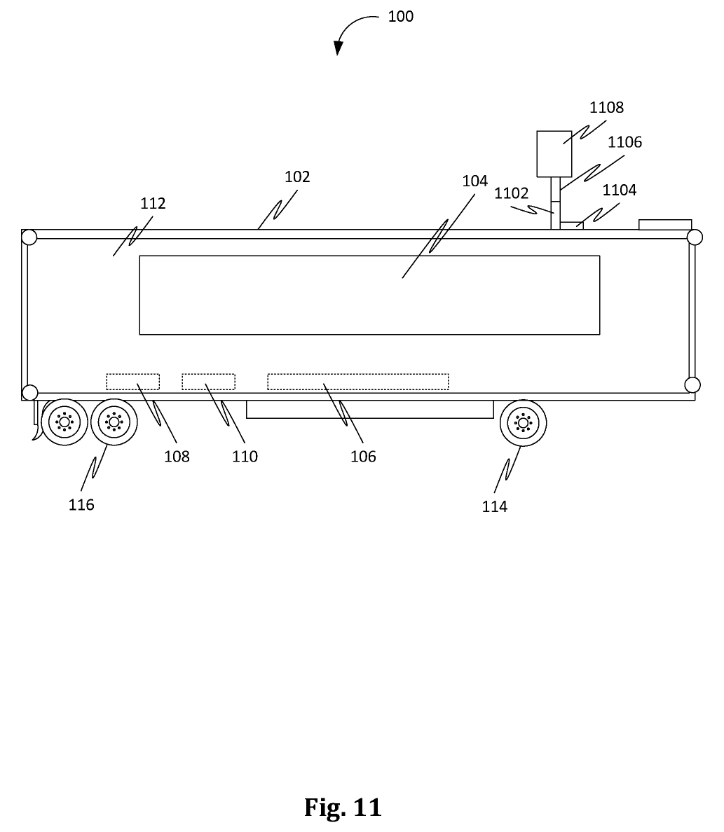

FIG. 11 is a side view of the apparatus 100 for facilitating the movement of the one or more trailers 102, in accordance with some embodiments. Further, the apparatus 100 may include the one or more electrical coupling elements 1102 and the one or more energy transfer controllers 1104.

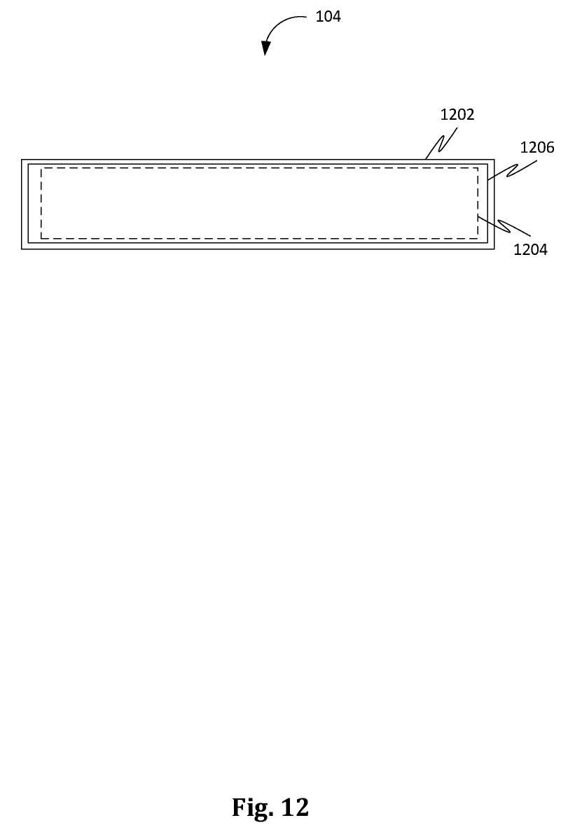

FIG. 12 is a front view of the one or more energy harvesting devices 104 of the apparatus 100 for facilitating the movement of the one or more trailers 102, in accordance with some embodiments. Further, the one or more energy harvesting devices 104 of the apparatus 100 may include the one or more solar energy harvesting devices 1202.

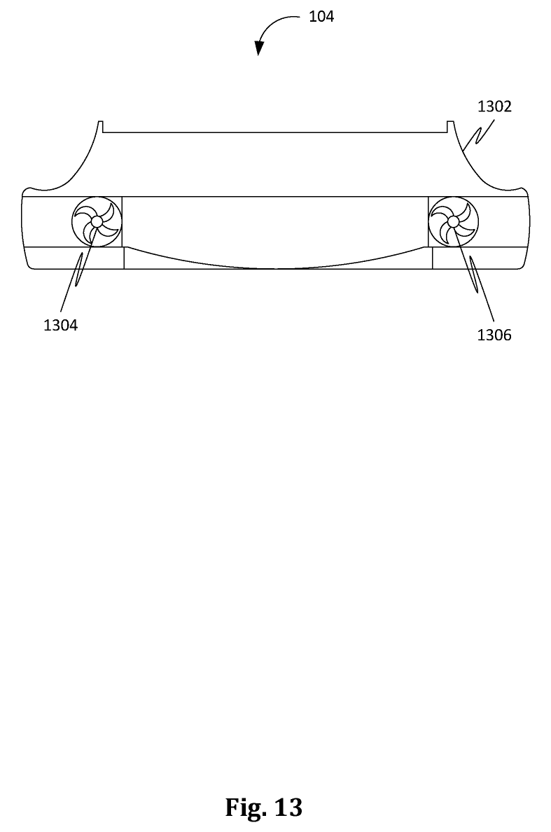

FIG. 13 is a side view of the apparatus 100 for facilitating the movement of the one or more trailers 102, in accordance with some embodiments. Further, the one or more energy harvesting devices 104 of the apparatus 100 may include the one or more wind energy harvesting devices 1302.

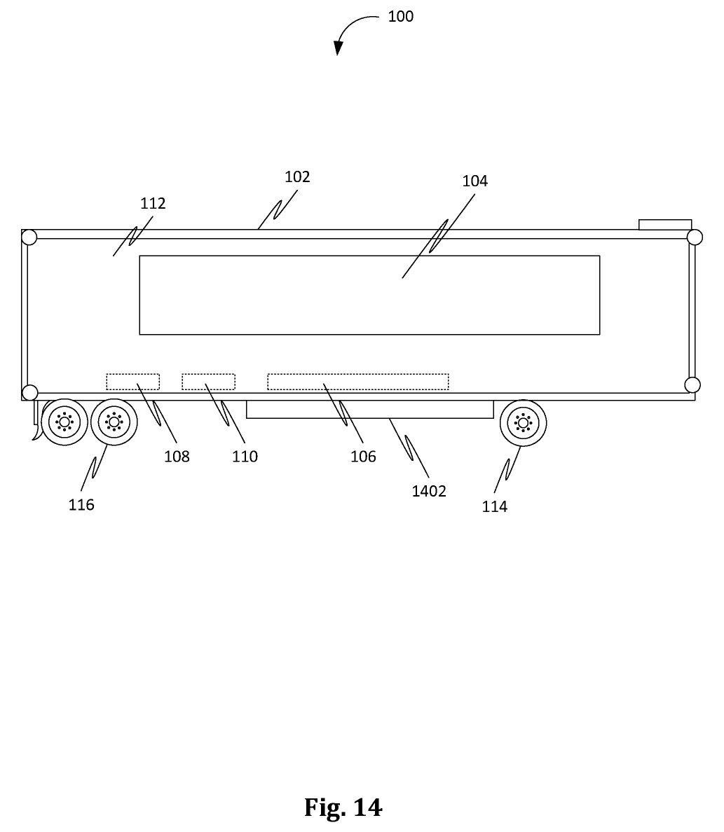

FIG. 14 is a side view of the apparatus 100 for facilitating the movement of the one or more trailers 102, in accordance with some embodiments. Further, the one or more energy harvesting devices 104 of the apparatus 100 may include the one or more inductive power harvesting devices 1402.

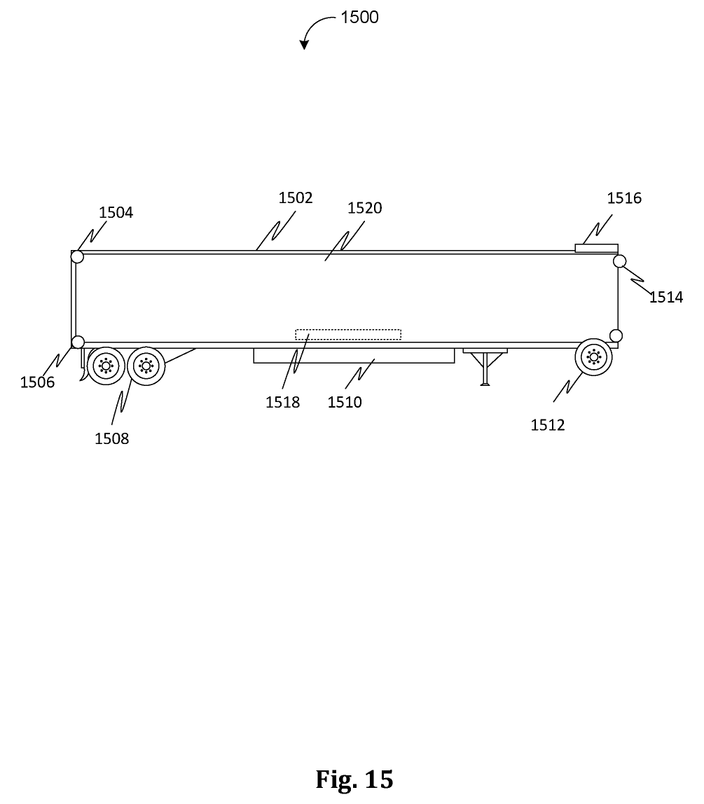

FIG. 15 is a side view of a trailer 1500 for facilitating movement of the trailer 1500, in accordance with some embodiments. Further, the trailer 1500 may include a trailer body 1502, a sensor 1504, a camera 1506, a rear wheel 1508, a wireless inductive charger 1510, a front steering wheel 1512, a LIDAR camera 1514, a wind turbine 1516, a battery pack 1518, and a solar energy harvester 1520.

FIG. 16 is a front view of a trailer system 1600 for facilitating movement of the trailer system 1600, in accordance with some embodiments. Further, the trailer system 1600 may be Solax trailer system.

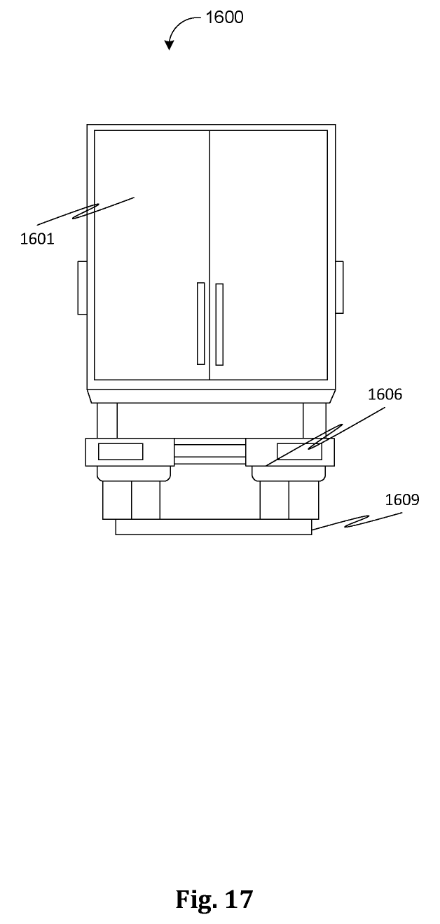

FIG. 17 is a rear view of the trailer system 1600 for facilitating movement of the trailer system 1600, in accordance with some embodiments. Further, the trailer system 1600 may include a trailer and a tractor.

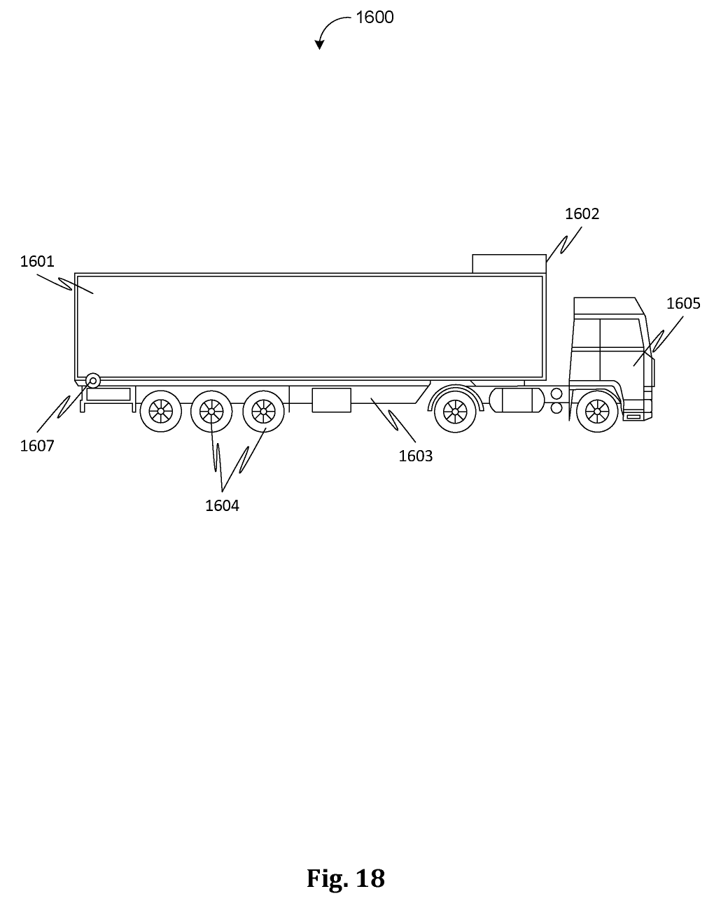

FIG. 18 is a left side view of the trailer system 1600 for facilitating movement of the trailer system 1600, in accordance with some embodiments. Further, the trailer may include a chassis.

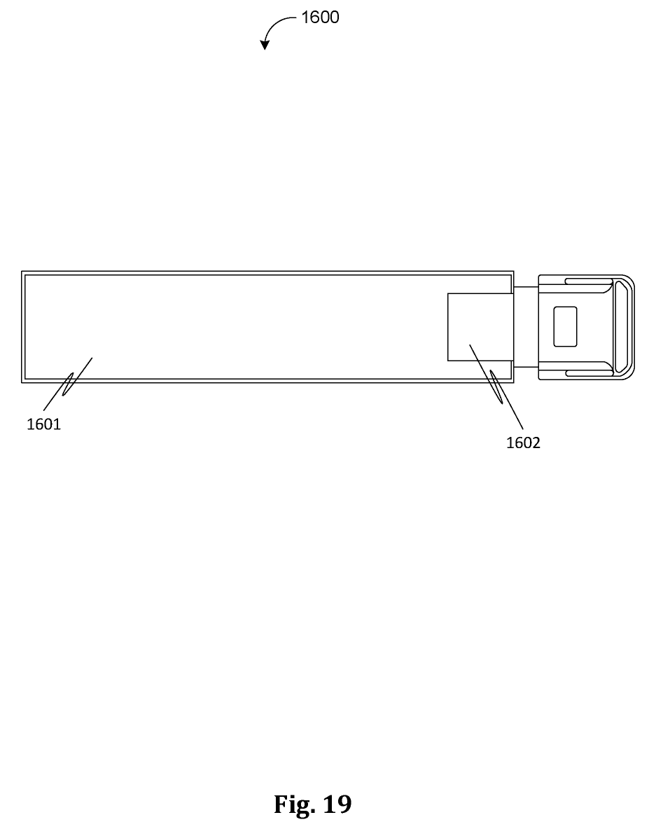

FIG. 19 is a top view of the trailer system 1600 for facilitating movement of the trailer system 1600, in accordance with some embodiments. Further, the tractor may include an autonomous tractor unit.

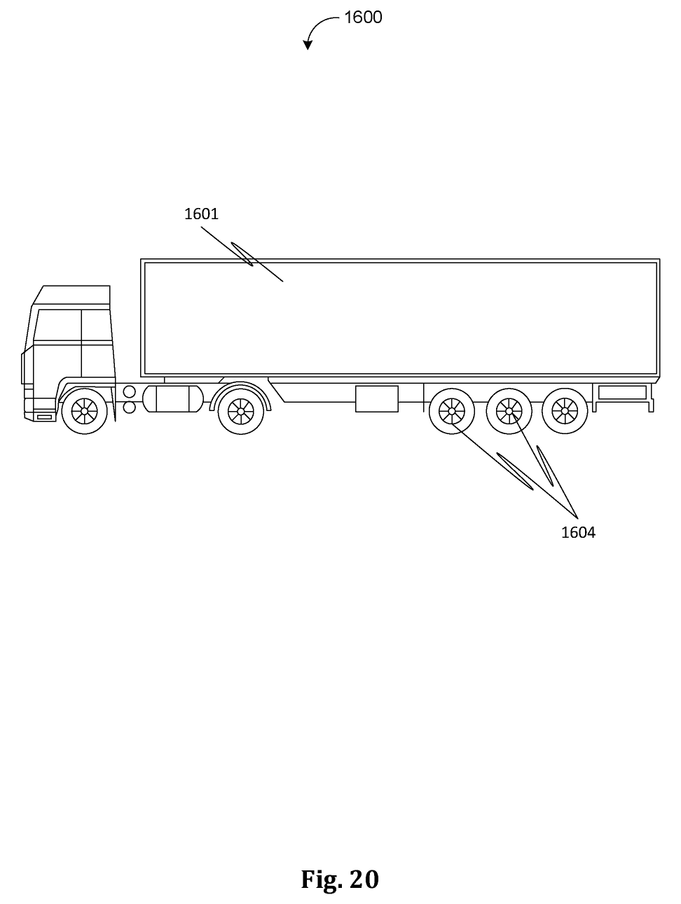

FIG. 20 is a right side view of the trailer system 1600 for facilitating movement of the trailer system 1600, in accordance with some embodiments. Further, the tractor may be removably connected to the trailer.

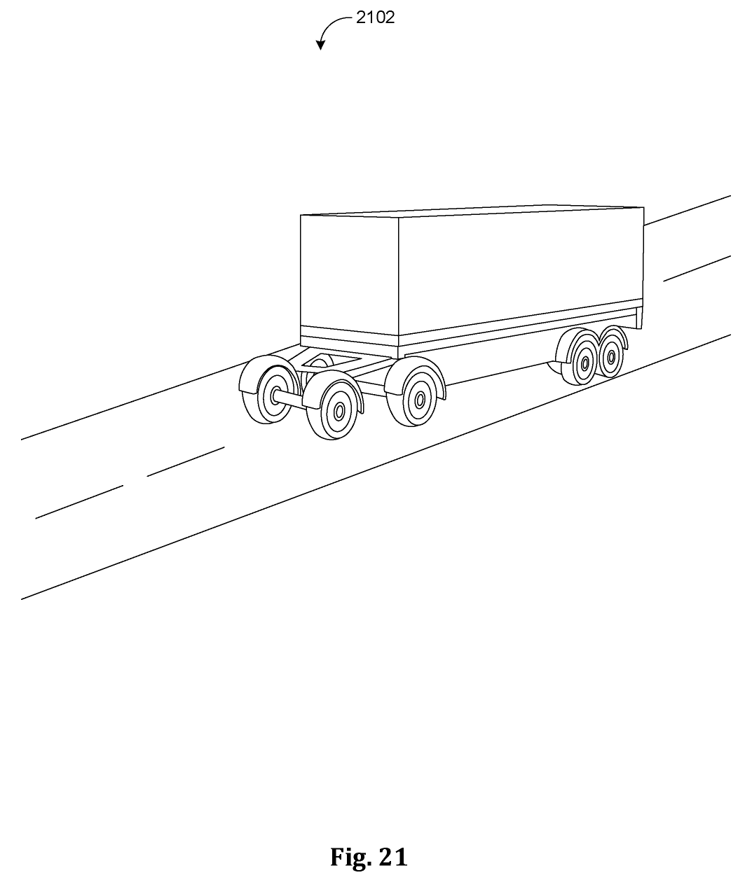

FIG. 21 illustrates a trailer 2102 traversing autonomously on a road, in accordance with some embodiments. Further, the trailer 2102 propels and maneuvers for traversing on the road.

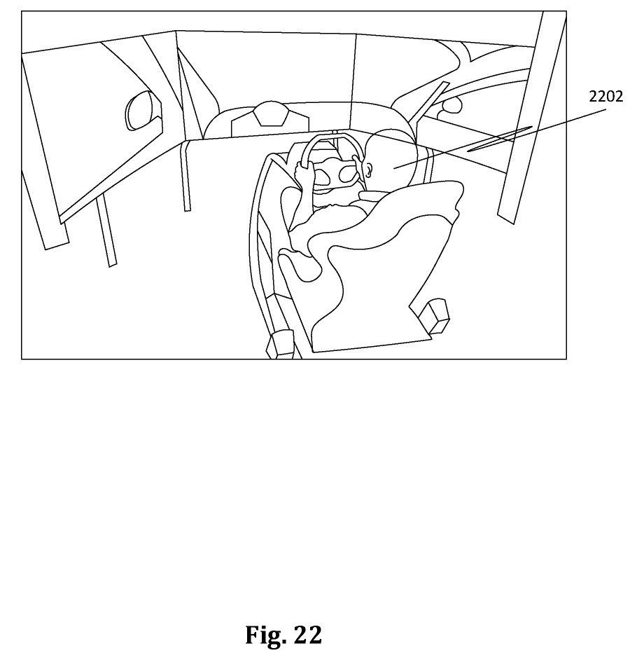

FIG. 22 illustrates a user 2202 controlling the trailer 2102 from a remote location, in accordance with some embodiments. Further, the user 2202 may control the trailer 2102 wirelessly.

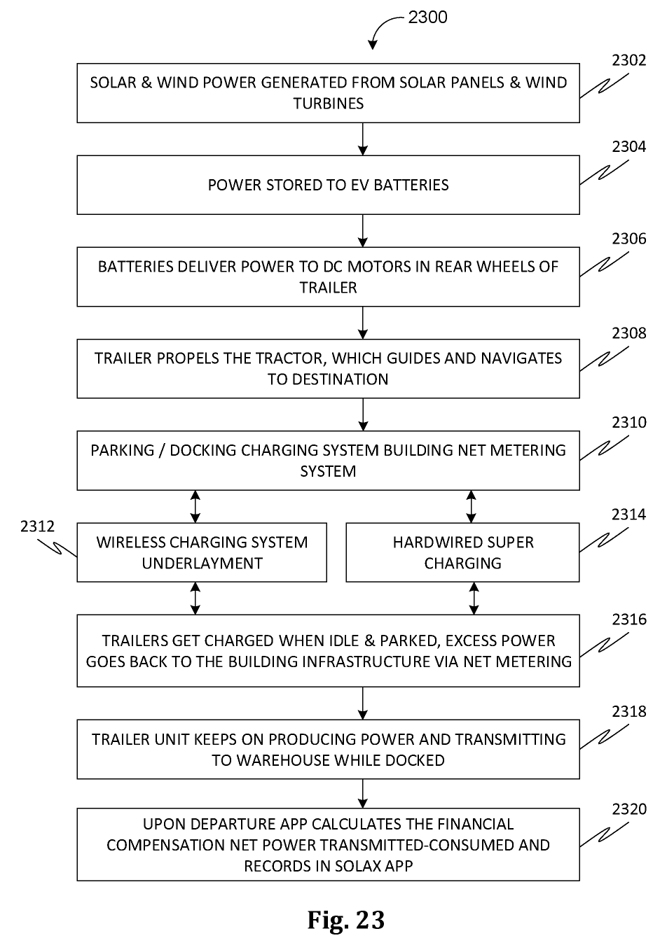

FIG. 23 is a flow diagram of a method 2300 for facilitating a movement of a trailer, in accordance with some embodiments. Accordingly, the method 2300 may include a step 2302 of generating solar & wind power generated from solar panels & wind turbines. Further, the method 2300 may include a step 2304 of storing power in EV batteries. Further, the method 2300 may include a step 2306 of batteries delivering power to DC motors in the rear wheels of the trailer. Further, the method 2300 may include a step 2308 of trailer propelling the tractor, which guides and navigates to the destination. Further, the method 2300 may include a step 2310 of parking/docking charging system, building a net metering system. Further, the method 2300 may include a step 2316 of trailers getting charged when idle & parked, excess power going back to the building infrastructure via net metering via a wireless charging system underlayment 2312, and a hardwired super charging 2314. Further, the method 2300 may include a step 2318 of the trailer unit keeping on producing power and transmitting to the warehouse while docked. Further, the method 2300 may include a step 2320 of, upon departure app calculates the financial compensation, net power transmitted-consumed, and records it in the Solax App.

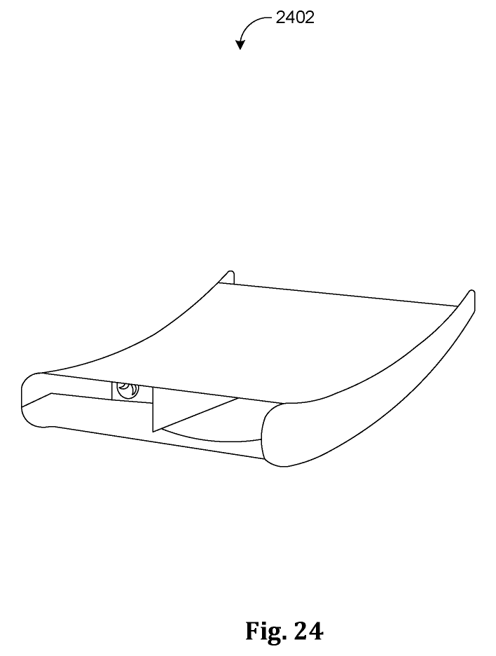

FIG. 24 is a perspective view of a wind energy harvesting device 2402, in accordance with some embodiments. Further, the wind energy harvesting device 2402 may include wind turbines.

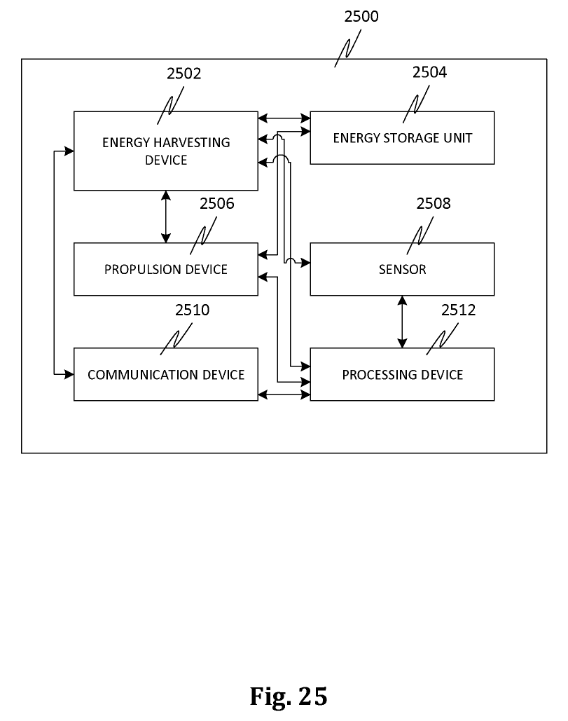

FIG. 25 is a block diagram of a smart-vehicle system 2500, in accordance with some embodiments. Further, the smart-vehicle system 2500 may include and/or may be the apparatus. Accordingly, the smart-vehicle system 2500 may include an energy harvesting device 2502, which may be configured for generating energy based on an external energy source. Further, the energy harvesting device 2502 may be disposed on a part of a vehicle. Further, the smart-vehicle system 2500 may include an energy storage unit 2504, which may be configured for storing the energy. Further, the energy storage unit 2504 may be operatively coupled to the energy harvesting device 2502. Further, the smart-vehicle system 2500 may include a propulsion device, which may be configured for propelling the vehicle based on the energy. Further, the propulsion device may be operatively coupled to the energy storage unit 2504. Further, the smart-vehicle system 2500 may include a sensor that may be configured for detecting an environmental characteristic associated with the propelling of the vehicle. Further, the sensor may be disposed on the part of the device. Further, the smart-vehicle system 2500 may include a communication device 2510 which may be configured for receiving a user command data corresponding to a user command associated with the propelling of the vehicle. Further, the user command data may be received from a user device associated with a user. Further, the smart-vehicle system 2500 may include a processing device which may be configured for generating a propulsion command data based on each of the environmental characteristics and the user command data. Further, the propelling of the vehicle may be based on the propulsion command data. Further, the processing device may be communicatively coupled to the propulsion device.

In some embodiments, the energy harvesting device 2502 includes a solar device which may be configured for generating an electrical energy based on a solar energy source. Further, the solar energy source corresponds to sunlight.

In some embodiments, the solar device includes a thin-film panel corresponding to a thin-film of two or more photovoltaic cells integrated into a panel. Further, the thin-film panel may be configured to convert the sunlight into the electrical energy.

In some embodiments, the energy harvesting device 2502 includes a wind turbine which may be configured for generating the electrical energy based on the propelling of the vehicle. Further, the generating of the electrical energy may be further based on a wind generated based on the propelling of the vehicle. Further, the wind turbine may include a plurality of wind turbines. Further, each of the plurality of wind turbines may be configured for generating the electrical energy.

In some embodiments, the generation of energy may be further based on an application of a solar paint on a part associated with the vehicle.

In some embodiments, the sensor includes two or more sensors. Further, each of the two or more sensors may be configured for detecting two or more environmental characteristics.

In some embodiments, the two or more sensors include a LiDAR sensor, which may be configured for detecting a distance associated with the propelling of the vehicle.

In some embodiments, the detecting the distance using the LiDAR sensor may be based on emission of a pulse of light.

In some embodiments, the two or more sensors include a camera. Further, the environmental characteristic includes a visual characteristic in relation to the propelling of the vehicle.

In some embodiments, the two or more sensors include an ultrasonic sensor which may be configured for detecting a distance associated with the propelling of the vehicle.

In some embodiments, the detecting the distance using the ultrasonic sensor may be based on emission of an ultrasonic wave.

In some embodiments, the two or more sensors include an obstacle sensor which may be configured for detecting an obstacle associated with the propelling of the vehicle.

In some embodiments, the vehicle includes a semi-trailer truck. Further, the energy harvesting device 2502 may be disposed on the part of a semi-trailer comprised in the semi-trailer truck.

In some embodiments, the smart-vehicle system 2500 may further include the communication device 2510, which may be configured for transmitting the propulsion command data to a user device associated with the user.

In some embodiments, the user command data includes a directional data corresponding to a direction associated with the propelling of the vehicle.

In some embodiments, the user command data includes one or more of a start command data and a stop command data. Further, the start command data corresponds to a start command in relation to the propelling of the vehicle. Further, the stop command data corresponds to a stop command in relation to the propelling of the vehicle.

In some embodiments, the user command data includes a synchronization data corresponding to a synchronization of two or more activities associated with the propelling of the vehicle.

In some embodiments, the processing device may be further configured for generating a vehicle status data corresponding to an operational status of the vehicle. Further, the communication device 2510 may be further configured for transmitting the vehicle status data to the user device.

In some embodiments, the smart-vehicle system 2500 may further include a power generation device, which may be configured for generating power based on the combustion of a fuel. Further, the power generation device is operatively coupled to the propulsion device.

In some embodiments, the power generation device includes a diesel engine.

In some embodiments, the fuel includes diesel.

In some embodiments, the smart-vehicle system 2500 may further include an energy recharging device, which may be configured for electrically recharging the energy storage device.

In some embodiments, the energy recharging device includes a wireless energy recharging device, which may be configured for electrically recharging the energy storage device wirelessly.

In some embodiments, electrically recharging the energy storage device wirelessly may be based on each of an inductive charging plate and a stationary charging pad.

In some embodiments, the inductive charging plate may be positioned beneath the vehicle.

In some embodiments, electrically recharging the energy storage device wirelessly may be based on each of an electromagnetic field.

In some embodiments, the smart-vehicle system 2500 may further include an energy-transfer terminal, which may be configured to be coupled to a load terminal associated with an external electric load. Further, the energy-transfer terminal may be electrically coupled to the energy harvesting device 2502.

In some embodiments, the external electric load includes an external power grid corresponding to a network that may be configured for transmitting electrical energy from a power plant to a user device associated with a user.

In some embodiments, the smart-vehicle system 2500 may further include a net metering device, which may be configured to generating an energy data corresponding to a record based on one or more of the receiving and the transmitting of the electrical energy.

In some embodiments, the propulsion device includes a high-torque electric motor, which may be configured for generating a rotary motion associated with a wheel. Further, the wheel may be associated with the vehicle.

In some embodiments, the electrically recharging of the energy storage device may be based on a regenerative braking technology corresponding to a braking technology that may be configured to generate electric energy based on an application of a brake associated with the vehicle.

In some embodiments, the semi-trailer includes two or more semi-trailers. Further, the propulsion device includes two or more propulsion devices associated with the two or more semi-trailers.

In some embodiments, the propulsion command data includes two or more propulsion command data associated with the each of the two or more propulsion devices.

In some embodiments, the processing device includes two or more processing devices. Further, the two or more processing devices include each of a truck-side processing device and a semi-trailer-side processing device.

In some embodiments, the truck-side processing device may be configured for generating a command data based on a user action associated with the propelling of the truck.

In some embodiments, the generating of the propulsion command data may be further based on the command data. Further, the propulsion device may be further configured for propelling the semi-trailer based on the propulsion command data.

In some embodiments, the user action includes one or more of an acceleration, a braking, and a change in direction associated with the propelling of the vehicle.

In some embodiments, the smart-vehicle system 2500 may further include a humanoid robotic device, which may be configured for mimicking a user action based on the user command data. Further, the humanoid robotic device includes each of a robot-side processing device and robot-side communication device.

In some embodiments, the robot-side processing device may be configured for user-representation command data based on the user command data. Further, the user-representation command data corresponds to a representation of the user action. Further, the user action includes one or more of an acceleration, a braking, and a change in direction associated with the propelling of the vehicle. Further, the generating of the propulsion command data may be based on the user-representation data.

In some embodiments, the robot-side processing device may be further configured for generating a vehicle status data corresponding to an operational status of the vehicle. Further, the robot-side communication device may be further configured for transmitting the vehicle status data to the user device.

In some embodiments, the motor includes a EV DC motor. Further, the EV DC motor includes two or more EV DC motors. Further, each of the two or more EV DC motors may be configured to generate the rotary motion.

In some embodiments, the energy storage device includes a Lithium battery pack.

In some embodiments, the Lithium battery pack may be positioned beneath the vehicle.

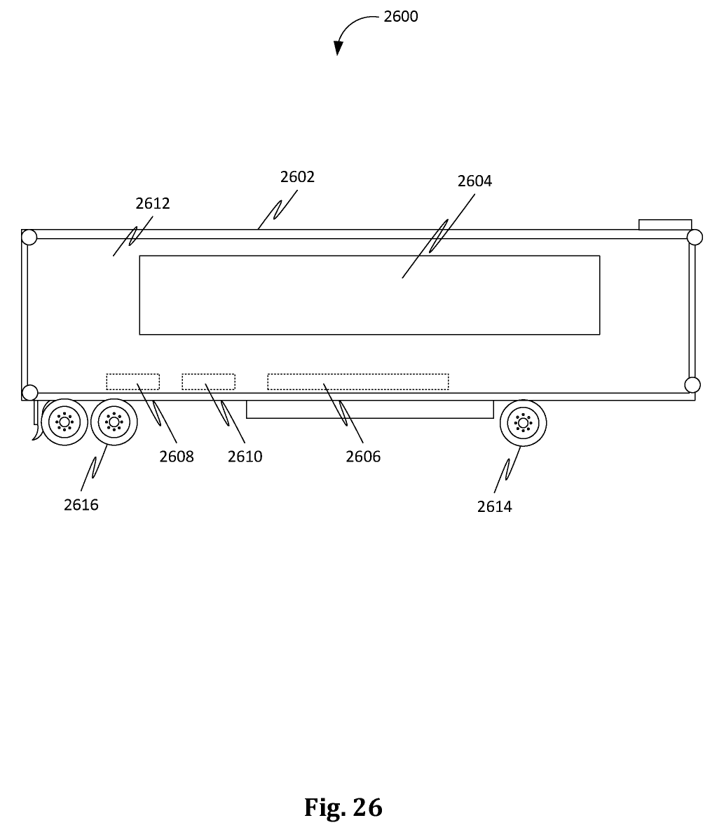

FIG. 26 is a side view of an apparatus 2600 for facilitating a movement of one or more trailers 2602, in accordance with some embodiments. Accordingly, the apparatus 2600 may include one or more trailers 2602, one or more energy harvesting devices 2604, one or more energy storage devices 2606, one or more trailer propulsion assemblies 2608, and a processing device 2610.

Further, the one or more trailers 2602 may include one or more trailer bodies 2612 and one or more wheels 2614-2616. Further, the one or more wheels 2614-2616 may be mounted on the one or more trailer bodies 2612.

Further, the one or more energy harvesting devices 2604 may be coupled to the one or more trailer bodies 2612 of the one or more trailers 2602. Further, the one or more energy harvesting devices 2604 may be configured for generating electrical energy by harvesting energy from an environment of the apparatus 2600.

Further, the one or more energy storage devices 2606 may be coupled to the one or more trailer bodies 2612. Further, the one or more energy storage devices 2606 may be electrically coupled with the one or more energy harvesting devices 2604. Further, the one or more energy storage devices 2606 may be configured for storing the electrical energy.

Further, the one or more trailer propulsion assemblies 2608 may be coupled to the one or more trailer bodies 2612. Further, the one or more trailer propulsion assemblies 2608 may be operatively coupled with the one or more wheels 2614-2616. Further, the one or more trailer propulsion assemblies 2608 may be configured for driving the one or more wheels 2614-2616 with one or more driving characteristics using the electrical energy for propelling the one or more trailers 2602. Further, the one or more trailers 2602 may be maneuverable.

Further, the processing device 2610 may be operatively coupled with the one or more trailer propulsion assemblies 2608, the one or more energy storage devices 2606, and the one or more energy harvesting devices 2604. Further, the processing device 2610 may be configured for generating one or more commands for controlling at least one movement of the one or more trailers 2602. Further, the driving of the one or more wheels 2614-2616 with the one or more driving characteristics using the electrical energy may be based on the one or more commands.

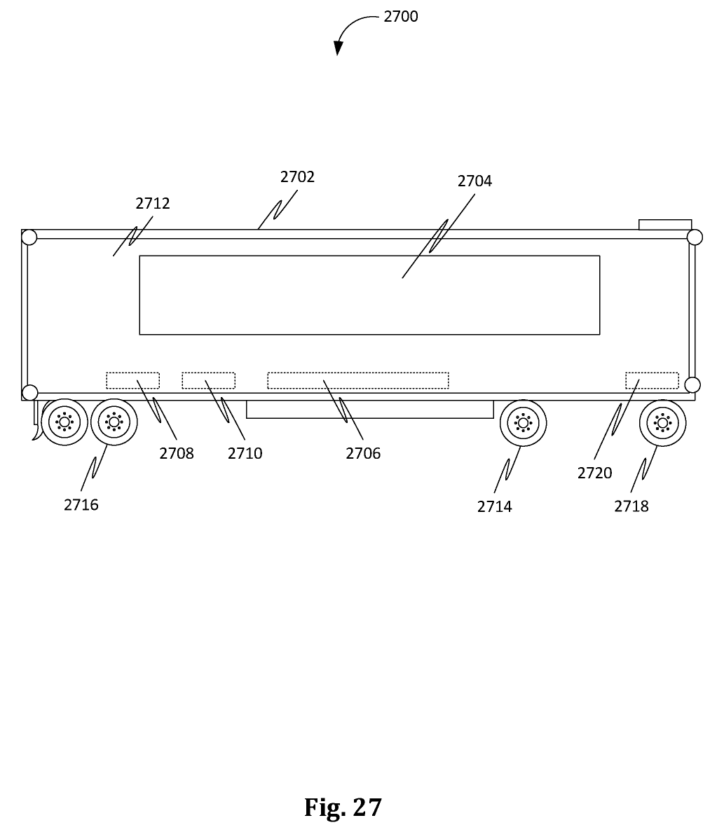

FIG. 27 is a side view of an apparatus 2700 for facilitating a movement of one or more trailers 2702, in accordance with some embodiments. Accordingly, the apparatus 2700 may include one or more trailers 2702, one or more energy harvesting devices 2704, one or more energy storage devices 2706, one or more trailer propulsion assemblies 2708, a processing device 2710, and one or more steering assemblies 2720.

Further, the one or more trailers 2702 may include one or more trailer bodies 2712, one or more wheels 2714-2716, and one or more steerable wheels 2718. Further, the one or more wheels 2714-2716 may be mounted to a rear portion of the one or more trailer bodies 2712. Further, the one or more steerable wheels 2718 may be mounted to a front portion of the one or more trailer bodies 2712.

Further, the one or more energy harvesting devices 2704 may be coupled to the one or more trailer bodies 2712 of the one or more trailers 2702. Further, the one or more energy harvesting devices 2704 may be configured for generating electrical energy by harvesting energy from an environment of the apparatus 2700.

Further, the one or more energy storage devices 2706 may be coupled to the one or more trailer bodies 2712. Further, the one or more energy storage devices 2706 may be electrically coupled with the one or more energy harvesting devices 2704. Further, the one or more energy storage devices 2706 may be configured for storing the electrical energy.

Further, the one or more trailer propulsion assemblies 2708 may be coupled to the one or more trailer bodies 2712. Further, the one or more trailer propulsion assemblies 2708 may be operatively coupled with the one or more wheels 2714-2716. Further, the one or more trailer propulsion assemblies 2708 may be configured for driving the one or more wheels 2714-2716 with one or more driving characteristics using the electrical energy for propelling the one or more trailers 2702. Further, the one or more trailers 2702 may be maneuverable.

Further, the processing device 2710 may be operatively coupled with the one or more trailer propulsion assemblies 2708, the one or more energy storage devices 2706, and the one or more energy harvesting devices 2704. Further, the processing device 2710 may be configured for generating one or more commands for controlling at least one movement of the one or more trailers 2702. Further, the driving of the one or more wheels 2714-2716 with the one or more driving characteristics using the electrical energy may be based on the one or more commands.

Further, the one or more steering assemblies 2720 may be coupled to the one or more trailer bodies 2712. Further, the one or more steering assemblies 2720 may be configured for steering the one or more steerable wheels 2718 based on the one or more commands. Further, the one or more trailers 2702 may be maneuvered based on the steering of the one or more steerable wheels 2718.

In some embodiments, the one or more trailer propulsion assemblies 108 may be and/or may include the one or more electric propulsion assemblies.

In some embodiments, the one or more energy storage devices 106 may be and/or may include the onboard energy storage assembly.

In some embodiments, the processing device 110 may be and/or may include the trailer-resident electronic control unit (ECU).

In some embodiments, the one or more commands may be and/or may include one or more of the propulsion control signals and the propulsion torque commands.

In some embodiments, the communication device 406 may be and/or may include the communication interface.

In some embodiments, the one or more robotic assemblies 604 may be and/or may include the robotic actuation assembly.

In some embodiments, the one or more trailers 102 may be and/or may include one or more semi-trailers.

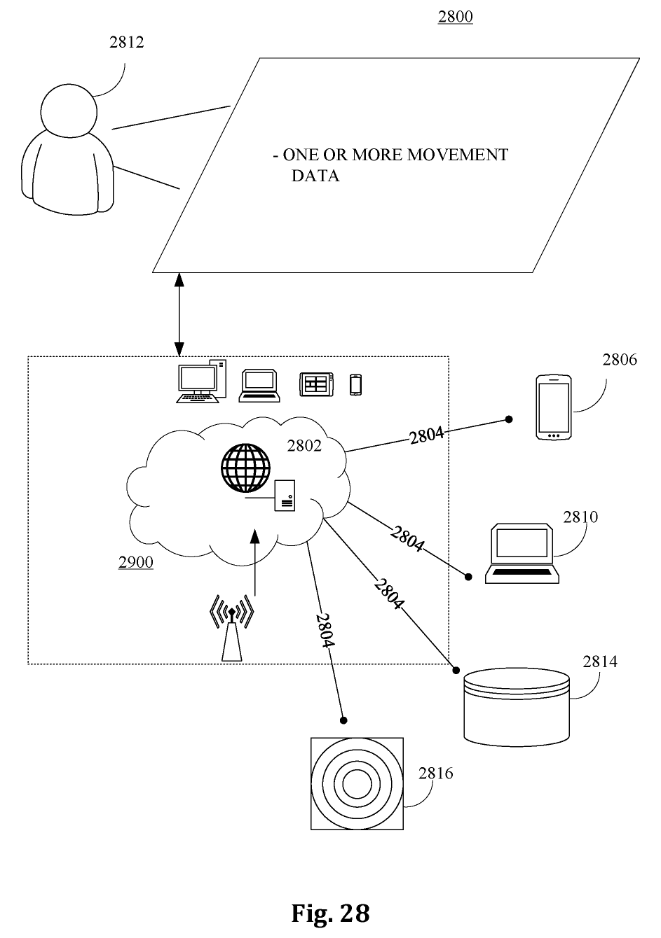

FIG. 28 is an illustration of an online platform 2800 consistent with various embodiments of the present disclosure. By way of non-limiting example, the online platform 2800 to facilitate managing a movement of one or more trailers may be hosted on a centralized server 2802, such as, for example, a cloud computing service. The centralized server 2802 may communicate with other network entities, such as, for example, a mobile device 2806 (such as a smartphone, a laptop, a tablet computer, etc.), other electronic devices 2810 (such as desktop computers, server computers, etc.), databases 2814, and sensors 2816 over a communication network 2804, such as, but not limited to, the Internet. Further, users of the online platform 2800 may include relevant parties such as, but not limited to, end-users, administrators, service providers, service consumers, and so on. Accordingly, in some instances, electronic devices operated by the one or more relevant parties may be in communication with the platform.

A user 2812, such as the one or more relevant parties, may access online platform 2800 through a web based software application or browser. The web based software application may be embodied as, for example, but not be limited to, a website, a web application, a desktop application, and a mobile application compatible with a computing device 2900.

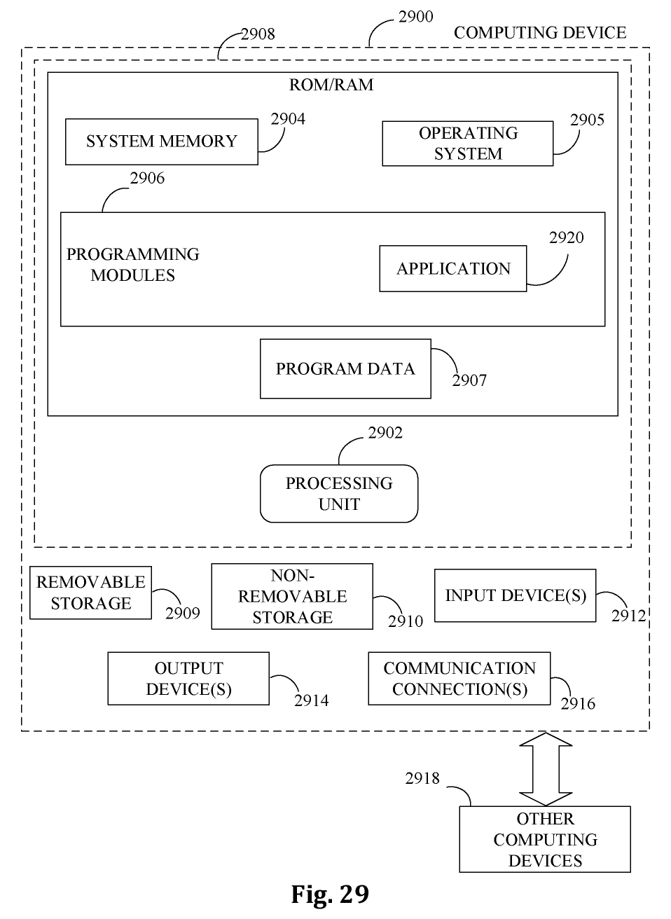

With reference to FIG. 29, a system consistent with an embodiment of the disclosure may include a computing device or cloud service, such as computing device 2900. In a basic configuration, computing device 2900 may include at least one processing unit 2902 and a system memory 2904. Depending on the configuration and type of computing device, system memory 2904 may comprise, but is not limited to, volatile (e.g. random-access memory (RAM)), non-volatile (e.g. read-only memory (ROM)), flash memory, or any combination. System memory 2904 may include operating system 2905, one or more programming modules 2906, and may include a program data 2907. Operating system 2905, for example, may be suitable for controlling computing device 2900’s operation. In one embodiment, programming modules 2906 may include image-processing modules, machine learning modules, etc. Furthermore, embodiments of the disclosure may be practiced in conjunction with a graphics library, other operating systems, or any other application program and is not limited to any particular application or system. This basic configuration is illustrated in FIG. 29 by those components within a dashed line 2908.

Computing device 2900 may have additional features or functionality. For example, computing device 2900 may also include additional data storage devices (removable and/or non-removable) such as, for example, magnetic disks, optical disks, or tape. Such additional storage is illustrated in FIG. 29 by a removable storage 2909 and a non-removable storage 2910. Computer storage media may include volatile and non-volatile, removable, and non-removable media implemented in any method or technology for storage of information, such as computer-readable instructions, data structures, program modules, or other data. System memory 2904, removable storage 2909, and non-removable storage 2910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), other optical storage, magnetic cassettes, magnetic tape, magnetic disk storage or other magnetic storage devices, or any other medium which can be used to store information and which can be accessed by computing device 2900. Any such computer storage media may be part of device 2900. Computing device 2900 may also have input device(s) 2912 such as a keyboard, a mouse, a pen, a sound input device, a touch input device, a location sensor, a camera, a biometric sensor, etc. Output device(s) 2914 such as a display, speakers, a printer, etc. may also be included. The aforementioned devices are examples and others may be used.

Computing device 2900 may also contain a communication connection 2916 that may allow device 2900 to communicate with other computing devices 2918, such as over a network in a distributed computing environment, for example, an intranet or the Internet. Communication connection 2916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2904, including operating system 2905. While executing on processing unit 2902, programming modules 2906 (e.g., application 2920 such as a media player) may perform processes including, for example, one or more stages of methods, algorithms, systems, applications, servers, databases as described above. The aforementioned process is an example, and processing unit 2902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating a movement of one or more trailers, the apparatus comprising:
one or more energy harvesting devices coupled to one or more trailer bodies of the one or more trailers, wherein the one or more energy harvesting devices are configured for generating electrical energy by harvesting energy from an environment of the apparatus;
one or more energy storage devices coupled to the one or more trailer bodies, wherein the one or more energy storage devices are electrically coupled with the one or more energy harvesting devices, wherein the one or more energy storage devices are configured for storing the electrical energy;
one or more trailer propulsion assemblies coupled to the one or more trailer bodies, wherein the one or more trailer propulsion assemblies are operatively coupled with one or more wheels mounted on the one or more trailer bodies, wherein the one or more trailer propulsion assemblies are configured for driving the one or more wheels with one or more driving characteristics using the electrical energy for propelling the one or more trailers, wherein the one or more trailers are maneuverable; and
a processing device operatively coupled with the one or more trailer propulsion assemblies, the one or more energy storage devices, and the one or more energy harvesting devices, wherein the processing device is configured for generating one or more commands for controlling at least one movement of the one or more trailers, wherein the driving of the one or more wheels with the one or more driving characteristics using the electrical energy is based on the one or more commands.

2. The apparatus of claim 1, wherein the one or more wheels are mounted to a rear portion of the one or more trailer bodies, wherein the one or more trailers comprise one or more steerable wheels mounted to a front portion of the one or more trailer bodies, wherein the apparatus further comprises one or more steering assemblies coupled to the one or more trailer bodies, wherein the one or more steering assemblies are configured for steering the one or more steerable wheels based on the one or more commands, wherein the one or more trailers are maneuvered based on the steering of the one or more steerable wheels.

3. The apparatus of claim 2, wherein the processing device is configured for:
analyzing one or more movement data; and
determining one or more movement characteristics for the at least one movement associated with the one or more trailers based on the analyzing of the one or more movement data, wherein the generating of the one or more commands is further based on the one or more movement characteristics.

4. The apparatus of claim 3 further comprising one or more sensors coupled to the one or more trailer bodies, wherein the one or more sensors are communicatively coupled with the processing device, wherein the one or more sensors are configured for detecting one or more parameters associated with the at least one movement of the one or more trailers, wherein the processing device is configured for generating the one or more movement data associated with the at least one movement of the one or more trailers based on the detecting of the one or more parameters, wherein the analyzing of the one or more movement data is further based on the generating of the one or more movement data.

5. The apparatus of claim 3, wherein the one or more trailers are coupled with a tractor, wherein the tractor comprises one or more tractor controllers, wherein the apparatus comprises a communication device communicatively coupled with the processing device, wherein the communication device is configured for receiving the one or more movement data from the one or more tractor controllers, wherein the one or more movement data is further associated with one or more movement operations associated with the tractor.

6. The apparatus of claim 5, wherein the tractor comprises one or more tractor sensors communicatively coupled with the one or more tractor controllers, wherein the one or more tractor sensors are configured for detecting one or more actions performed on one or more physical interfaces of the tractor, wherein the one or more actions correspond to the one or more movement operations associated with the tractor, wherein the one or more tractor controllers are configured for generating the one or more movement data based on the detecting of the one or more actions.

7. The apparatus of claim 5, wherein the tractor comprises at least one robotic assembly and one or more physical interfaces, wherein the at least one robotic assembly is configured for performing one or more actions on the one or more physical interfaces, wherein the one or more tractor controllers are configured for generating the one or more movement data based on the performing of the one or more actions.

8. The apparatus of claim 7, wherein the at least one robotic assembly is configured for receiving one or more control commands from one or more external devices, wherein the performing of the one or more actions on the one or more physical interfaces by the at least one robotic assembly is based on the one or more control commands.

9. The apparatus of claim 5, wherein the tractor further comprises at least one tractor propulsion assembly, at least one tractor steering assembly, and a control assembly, wherein the at least one tractor propulsion assembly is operatively coupled with at least one propulsion interface of the tractor, wherein the at least one tractor steering assembly is operatively coupled with at least one steering interface of the tractor, wherein the control assembly is configured for transitioning between a first state and a second state, wherein the at least one propulsion interface is configured for actuating the at least one tractor propulsion assembly in the first state, wherein the at least one steering interface is configured for actuating the at least one tractor steering assembly in each of the first state and the second state, wherein the one or more tractor controllers are further configured for:
generating one or more first movement data in the first state;
generating one or more second movement data in the second state, wherein the one or more movement data comprises the one or more first movement data during the first state, wherein the one or more movement data comprises the one or more second movement data during the second state.

10. The apparatus of claim 1 further comprising a communication device communicatively coupled with the processing device, wherein the communication device is configured for receiving one or more movement data from one or more external devices, wherein the processing device is further configured for:
analyzing the one or more movement data; and
determining one or more movement characteristics for the at least one movement of the one or more trailers based on the analyzing, wherein the generating of the one or more commands is further based on the one or more movement characteristics.

11. The apparatus of claim 1, wherein the one or more trailers comprise two or more trailers, wherein the one or more trailer bodies comprise two or more trailer bodies of the two or more trailers, wherein the two or more trailer bodies are mechanically coupled in series, wherein the one or more energy harvesting devices comprise two or more energy harvesting devices, wherein each of the two or more energy harvesting devices is coupled with a respective trailer body of the two or more trailer bodies, wherein the one or more energy storage devices comprise two or more energy storage devices, wherein each of the two or more energy storage devices is coupled with a respective trailer body of the two or more trailer bodies, wherein each of the two or more energy storage devices is electrically coupled with a respective energy harvesting device of the two or more energy harvesting devices, wherein the one or more trailer propulsion assemblies comprise two or more trailer propulsion assemblies, wherein each of the two or more trailer propulsion assemblies is coupled to a respective trailer body of the two or more trailer bodies, wherein each of the two or more trailer propulsion assemblies is operatively coupled to the one or more wheels of the respective trailer body of the two or more trailer bodies, wherein the controlling of the at least one movement of the one or more trailers comprises controlling the at least one movement of each of the two or more trailers, wherein the driving of the one or more wheels with the one or more driving characteristics using the electrical energy comprises independently driving, by each of the two or more trailer propulsion assemblies, the one or more wheels of the respective trailer body of the two or more trailer bodies with the one or more driving characteristics using the electrical energy from the respective energy storage device based on the one or more commands.

12. The apparatus of claim 11, wherein the processing device is further configured for dynamically determining the one or more driving characteristics for the one or more wheels of each of the two or more trailer bodies, wherein the independently driving, by each of the two or more trailer propulsion assemblies, of the one or more wheels of the respective trailer body of the two or more trailer bodies with the one or more driving characteristics of the one or more wheels of the respective trailer body using the electrical energy from the respective energy storage device is further based on the dynamically determining of the one or more driving characteristics for the one or more wheels of each of the two or more trailer bodies.

13. The apparatus of claim 1 further comprising one or more additional sensors communicatively coupled with the processing device, wherein the one or more additional sensors are configured for monitoring one or more additional parameters associated with at least one of the apparatus and the environment, wherein the processing device is configured for:
generating one or more additional sensor data based on the monitoring of the one or more additional parameters;
analyzing the one or more additional sensor data; and
determining one or more movement characteristics for the at least one movement associated with the one or more trailers based on the analyzing of the one or more additional sensor data, wherein the generating of the one or more commands is further based on the one or more movement characteristics.

14. The apparatus of claim 1 further comprising:
one or more electrical coupling elements coupled to the one or more trailer bodies, wherein the one or more electrical coupling elements are electrically coupled with the one or more energy storage devices, wherein the one or more electrical coupling elements are configured for connecting to one or more electrical interfaces of one or more electrical systems; and
one or more energy transfer controllers operatively coupled with the one or more energy storage devices, wherein the one or more energy transfer controllers are configured for enabling a transfer of the electrical energy between the one or more energy storage devices and the one or more electrical systems according to one or more constraints based on the connecting, wherein the processing device is operatively coupled with the one or more energy transfer controllers, wherein the processing device is further configured for:
determining the one or more constraints for the transfer of the electrical energy between the one or more energy storage devices and the one or more electrical systems; and
generating one or more transfer control commands based on the determining of the one or more constraints, wherein the enabling of the transfer of the electrical energy between the one or more energy storage devices and the one or more electrical systems according to the one or more constraints is further based on the one or more transfer control commands.

15. The apparatus of claim 14, wherein the processing device is further configured for:
determining an amount of the electrical energy transferred from the one or more energy storage devices to the one or more electrical systems;
generating one or more energy credits based on the amount of the electrical energy transferred from the one or more energy storage devices to the one or more electrical systems; and
transferring the one or more energy credits to one or more accounts.

16. The apparatus of claim 1, wherein the one or more energy harvesting devices comprise one or more solar energy harvesting devices, wherein the one or more solar energy harvesting devices comprise one or more coatings of one or more solar paints applied to one or more exterior surfaces of the one or more trailer bodies, and one or more transparent film cells disposed on the one or more exterior surfaces over the one or more coatings of the one or more solar paints, wherein the one or more solar energy harvesting devices are configured for harvesting the electrical energy from light in the environment.

17. The apparatus of claim 1, wherein the one or more energy harvesting devices comprise one or more wind energy harvesting devices, wherein the one or more wind energy harvesting devices comprise one or more wind turbines mounted on one or more locations of the one or more trailer bodies, wherein the one or more wind energy harvesting devices are configured for harvesting the electrical energy from the wind in the environment.

18. The apparatus of claim 1, wherein the one or more energy harvesting devices comprise one or more inductive power harvesting devices, wherein the one or more inductive power harvesting devices comprise one or more inductive power transfer interfaces, wherein the one or more inductive power transfer interfaces are mounted to one or more locations on the one or more trailer bodies, wherein the one or more inductive power harvesting devices are configured for harvesting the electrical energy from electromagnetic energy.

19. An apparatus for facilitating a movement of one or more trailers, the apparatus comprising:
one or more trailers comprising one or more trailer bodies and one or more wheels, wherein the one or more wheels are mounted on the one or more trailer bodies;
one or more energy harvesting devices coupled to the one or more trailer bodies of the one or more trailers, wherein the one or more energy harvesting devices are configured for generating electrical energy by harvesting energy from an environment of the apparatus;
one or more energy storage devices coupled to the one or more trailer bodies, wherein the one or more energy storage devices are electrically coupled with the one or more energy harvesting devices, wherein the one or more energy storage devices are configured for storing the electrical energy;
one or more trailer propulsion assemblies coupled to the one or more trailer bodies, wherein the one or more trailer propulsion assemblies are operatively coupled with the one or more wheels, wherein the one or more trailer propulsion assemblies are configured for driving the one or more wheels with one or more driving characteristics using the electrical energy for propelling the one or more trailers, wherein the one or more trailers are maneuverable; and
a processing device operatively coupled with the one or more trailer propulsion assemblies, the one or more energy storage devices, and the one or more energy harvesting devices, wherein the processing device is configured for generating one or more commands for controlling at least one movement of the one or more trailers, wherein the driving of the one or more wheels with the one or more driving characteristics using the electrical energy is based on the one or more commands.

20. An apparatus for facilitating a movement of one or more trailers, the apparatus comprising:
one or more trailers comprising one or more trailer bodies, one or more wheels, and one or more steerable wheels, wherein the one or more wheels are mounted to a rear portion of the one or more trailer bodies, wherein the one or more steerable wheels are mounted to a front portion of the one or more trailer bodies;
one or more energy harvesting devices coupled to the one or more trailer bodies of the one or more trailers, wherein the one or more energy harvesting devices are configured for generating electrical energy by harvesting energy from an environment of the apparatus;
one or more energy storage devices coupled to the one or more trailer bodies, wherein the one or more energy storage devices are electrically coupled with the one or more energy harvesting devices, wherein the one or more energy storage devices are configured for storing the electrical energy;
one or more trailer propulsion assemblies coupled to the one or more trailer bodies, wherein the one or more trailer propulsion assemblies are operatively coupled with the one or more wheels, wherein the one or more trailer propulsion assemblies are configured for driving the one or more wheels with one or more driving characteristics using the electrical energy for propelling the one or more trailers, wherein the one or more trailers are maneuverable;
a processing device operatively coupled with the one or more trailer propulsion assemblies, the one or more energy storage devices, and the one or more energy harvesting devices, wherein the processing device is configured for generating one or more commands for controlling at least one movement of the one or more trailers, wherein the driving of the one or more wheels with the one or more driving characteristics using the electrical energy is based on the one or more commands; and
one or more steering assemblies coupled to the one or more trailer bodies, wherein the one or more steering assemblies are configured for steering the one or more steerable wheels based on the one or more commands, wherein the one or more trailers are maneuvered based on the steering of the one or more steerable wheels.
